(19) United States
(12) Patent Application Publication
(10) Pub. No.: US 2003/0189192 A1
(43) Pub. Date: Oct. 9, 2003

(54) Stabilizing mixtures for organic polymers

(76) Inventors: Daniele Girelli, Milan (IT); Fabjo Broussard, Brusaporto-Bergamo (IT); Vincenzo Malatesta, Maurizio Al (IT)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/239,633

(22) PCT Filed: Mar. 23, 2001
(86) PCT No.: PCT/EP01/03368

(51) Int. Cl. C09K 15/16; C09K 15/22; C09K 15/26; C09K 15/32

(52) U.S. Cl. 252/400.21; 252/400.24; 252/400.31; 252/401; 252/402; 252/403

(57) ABSTRACT

Stablizing mixtures for organic polymers comprising: (a) at least one compound belonging to the group of 3-pyrazolidinones; (b) at least one compound belonging to the group of organic phosphites or phosphonites; (c) at least one compound belonging to the group of sterically hindered phenols; and, optionally, (d) at least one compound belonging to the group of sterically hindered amines. The above mixtures can be used as stabilizers of organic polymers to degradation caused by oxygen, heat and/or light.

The present invention relates to stabilizing mixtures for organic polymers.

More specifically, the present invention relates to stabilizing mixtures for organic polymers comprising at least one compound belonging to the group of 3-pyrazolidinones, at least one compound belonging to the group of organic phosphites or phosphonites, at least one compound belonging to the group of sterically hindered phenols and, optionally, at least one compound belonging to the group of sterically hindered amines and their use in the stabilization of organic polymers to degradation caused by oxygen, heat and/or light.

The present invention also relates to the polymeric compositions stabilized with the above stabilizing mixtures and the end-products obtained by their processing.

Japanese patent application JP 56/086165 describes the use of derivatives of 3-pyrazolidinone as colour-stabilizers and antioxidants in the photographic field.

Organic phosphates, organic phosphonites and phosphoramides are known in the art as co-stabilizers, secondary antioxidants and process stabilizers for organic polymers among which polyolefins. Examples of these compounds can be found, for example, in R. Gächter/H. Müller (Ed.), “Plastic Additives Handbook” (1990), 3^{rd} Ed., page 47, Hanser, Münich.

U.S. Pat. No. 4,360,617 describes stabilizing mixtures comprising symmetrical triarylphosphites and phenolic antioxidants, particularly useful in the stabilization to degradation caused by oxygen, heat and/or light, of various organic polymers such as, for example, polyurethanes, polyacrylonitrile, polyamide 12 or polystyrene.

Sterically hindered amines, in particular those carrying 2,2,6,6-tetramethylpiperidine groups in the molecule, are known as HALS.

The known stabilizers, however, are not capable of completely satisfying all the problems to be solved by a stabilizer such as, for example, storage life, water absorption, sensitivity to hydrolysis, stabilization during the polymer processing, colour properties of the stabilized polymer, volatility, migration within the stabilized polymer, compatibility with the polymer to be stabilized and improvement in light protection. There is consequently a continuous need for stabilizers for organic polymers capable of providing a better stabilization thereof.

The Applicant has now found that stabilizing mixtures comprising at least one compound belonging to the group of 3-pyrazolidinones, at least one compound belonging to the group of organic phosphates or phosphonites, and, optionally, at least one compound belonging to the group of sterically hindered phenols and, optionally, at least one compound belonging to the group of sterically hindered amines, are capable of providing a better stabilization to degradation caused by oxygen, heat and/or light, of the organic polymers to which they are added.

An object of the present invention therefore relates to stabilizing mixtures for organic polymers comprising:

(a) at least one compound belonging to the group of 3-pyrazolidinones;

(b) at least one compound belonging to the group of organic phosphites or phosphonites; and, optionally,

(c) at least one compound belonging to the group of sterically hindered phenols; and, optionally,

(d) at least one compound belonging to the group of sterically hindered amines.

Compounds belonging to the group of 3-pyrazolidinones (a) useful for the purposes of the present invention are selected from those having general formula (I) or (II):

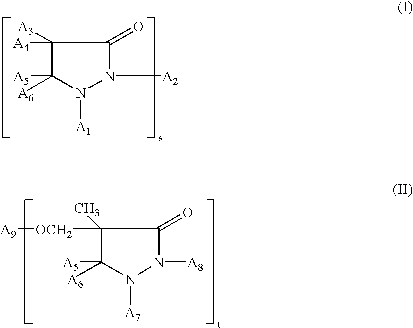

wherein:

A₁ represents a linear or branched C₁-C₁₈ alkyl group; a C₅-C₁₂ cycloalkyl group, said cycloalkyl group optionally mono-, di- or tri-substituted with a linear or branched C₁-C₄ alkyl group; a phenyl group, said phenyl group optionally mono-, di- or tri-substituted with a linear or branched C₁-C₄ alkyl or alkoxyl group, and/or mono-substituted with a hydroxyl group; a C₇-C₉ phenylalkyl group, said phenylalkyl group optionally mono-, di- or tri-substituted on the phenyl with a linear or branched C₁-C₄ alkyl group, and/or mono-substituted with a hydroxyl group; an —A₁₀—COOA₁₁ wherein A₁₀ represents a linear or branched C₁-C₆ alkylene group and A₁₁ represents a linear or branched C₁-C₁₈ alkyl group, a C₅-C₁₂ cycloalkyl group, said cycloalkyl group optionally mono-, di- or tri-substituted with a linear or branched C₁-C₄ alkyl group, a linear or branched C₃-C₁₈ alkenyl group, a C₇-C₉ phenylalkyl group, said phenylalkyl group optionally mono-, di- or tri-substituted on the phenyl with a linear or branched C₁-C₄ alkyl group;

A₃, A₄, A₅ and A₆, the same or different, represent a hydrogen atom; a linear or branched C₁-C₄ alkyl group; a phenyl group;

s is 1 or 2;

when s is 1, A₂ represents a hydrogen atom; a linear or branched C₁-C₁₈ alkyl group; a linear or branched C₃-C₆ alkenyl group; a C₇-C₉ phenylalkyl group, said phenylalkyl group optionally mono-, di- or tri-substituted on the phenyl with a linear or branched C₁-C₄ alkyl group; an —A₁₀—COOA₁₁ wherein A₁₀ and A₁₁ have the same meanings defined above; and, when A₂ represents a hydrogen atom, A₁ may also represent a group having general formula (III):

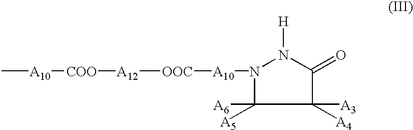

wherein A₃, A₄, A₅, A₆ and A₁₀ have the same meanings defined above and A₁₂ represents a linear or branched C₂-C₁₂ alkylene group; a C₄-C₁₂ alkylene group interrupted by 1, 2 or 3 oxygen atoms; a cyclohexylene group; a cyclohexylenedimethylene group; an isopropylidenedicyclohexylidene group;

when s is 2, A₂ represents a linear or branched C₂-C₁₂ alkylene group, or a xylylene group;

A₇ represents a phenyl group optionally mono-, di- or tri-substituted with a linear or branched C₁-C₄ alkyl or alkoxyl group, and/or mono-substituted with a hydroxyl group;

A₈ represents a hydrogen atom; a linear or branched C₁-C₁₈ alkyl group; a linear or branched C₃-C₆ alkenyl group; a C₇-C₉ phenylalkyl group, said phenylalkyl group optionally mono-, di-, or tri-substituted on the phenyl with a linear or branched C₁-C₄ alkyl group; an —A₁₀—COOA₁₁ group wherein A₁₀ and A₁₁ have the same meanings defined above;

t is 1, 2, 3 or 4;

when t is 1, A₉ represents an acyl-aliphatic, cycloaliphatic, aromatic, arylaliphatic or heterocyclic group containing not more than 22 carbon atoms; or one of the following groups having general formula (IVa)-(IVc):

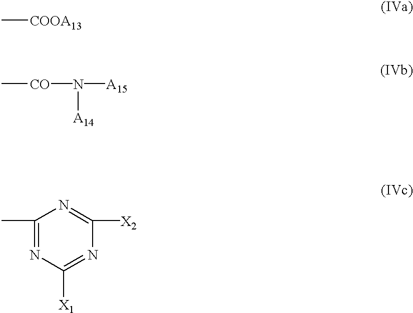

wherein A₁₃ has the same meanings as A₁₁ described above; A₁₄ and A₁₅, the same or different, have the same meanings as A₁₁ described above, or they represent a hydrogen atom, or a phenyl group, or A₁₄ and A₁₅ considered jointly with the nitrogen atom to which they are bound, represent a heterocyclic group with 5-7 atoms; X₁ and X₂, the same or different, represent an —O—A₁₆ group, or a group having the formula:

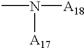

wherein A₁₆, A₁₇ and A₁₈, the same or different, have the same meanings as A₁₄ and A₁₅ described above, or A₁₇ and A₁₈ considered jointly with the nitrogen atom to which they are bound, represent a heterocyclic group with 5-7 atoms;

when t is 2, A₉ represents a diacyl-aliphatic, cycloaliphatic, aromatic, arylaliphatic or heterocyclic group containing not more than 22 carbon atoms; or one of the following groups having general formula (Va)-(Vc):

—COO—A₁₉—OOC— (Va)

—CONH—A₂₀—NHCO— (Vb)

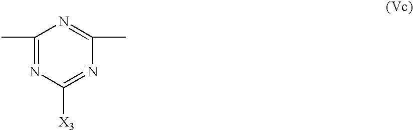

wherein A₁₉ represents a linear or branched C₂-C₁₂ alkylene group, a C₄-C₁₂ alkylene group interrupted by 1, 2 or 3 oxygen atoms, a cyclohexylene group, a cyclohexylenedimethylene group, an isopropylidenedicyclohexylidene group, a phenylene group, a xylylene group, an isopropylidenediphenylene group; A₂₀ represents a linear or branched C₂-C₁₂ alkylene group, a cyclohexylene group, a cyclohexylenedimethylene group, a methylidene-cyclohexylene group, a phenylene group, a methylphenylene group, a xylylene group, a methylenediphenylene group, an oxydiphenylene group, a group having the formula:

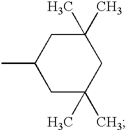

X₃′ has the same meanings as X₁ and X₂ defined above;

when t is 3, A₉ represents a triacyl-aliphatic, aromatic or heterocyclic group containing not more than 18 carbon atoms, or a 2,4,6-triyl-1,3,5-triazine group;

when n is 4, A₉ represents a tetra-acyl-aliphatic or aromatic group containing not more than 18 carbon atoms.

Examples of linear or branched alkyl groups, having not more than 18 carbon atoms are: methyl, ethyl, propyl, isopropyl, butyl, 2-butyl, isobutyl, t-butyl, pentyl, 2-pentyl, hexyl, heptyl, octyl, 2-ethylhexyl, t-octyl, nonyl, decyl, undecyl, dodecyl, tridecyl, pentadecyl, hexadecyl, heptadecyl, octadecyl, etc.

Examples of linear or branched alkoxyl groups, having not more than 18 carbon atoms are: methoxy, ethoxy, propoxy, isopropoxy, butoxy, isobutoxy, pentoxy, isopentoxy, hexoxy, heptoxy, octoxy, nonoxy, decyloxy, dodecyloxy, tetradecyloxy, hexadecyloxy, octadecyloxy, etc.

Examples of C₅-C₁₂ cycloalkyl groups, optionally mono-, di- or tri-substituted with a linear or branched C₁-C₄ alkyl group, are: cyclopentyl, methylcyclopentyl, dimethylcyclopentyl, cyclohexyl, methylcyclohexyl, dimethylcyclohexyl, trimethylcyclohexyl, t-butylcyclohexyl, cyclo-octyl, cyclodecyl, cyclododecyl, etc.

Examples of alkenyl groups having not more than 18 carbon atoms are: allyl, 2-methyallyl, butenyl, hexenyl, undecenyl, octadecenyl.

Examples of C₇-C₉ phenylalkyl groups, optionally mono-, di-, or tri-substituted on the phenyl, are: benzyl, methylbenzyl, dimethylbenzyl, trimethylbenzyl, t-butylbenzyl, 2-phenylethyl, 3,5-di-t-butyl-4-hydroxybenzyl, etc.

Examples of substituted phenyl groups are: methylphenyl, dimethylphenyl, trimethylphenyl, 3,5-di-t-butyl-4-methylphenyl, methoxyphenyl, ethoxyphenyl, dimethoxyphenyl, trimethoxyphenyl, hydroxyphenyl, 3,5-di-t-butyl-4-hydroxyphenyl, etc.

Examples of heterocyclic groups with 5-7 atoms are: 1-pyrrolidyl, 1-piperidyl, 4-morpholinyl, 4-methyl-1-piperazinyl, 1-hexahydroazepinyl, etc.

Examples of acyl-aliphatic, cycloaliphatic, aromatic, arylaliphatic or heterocyclic groups having not more than 22 carbon atoms are those deriving from the following acids: formic, acetic, propionic, butyric, isobutyric, valeric, pivalic, hexanoic, heptanoic, octanoic, 2-ethylhexanoic, nonanoic, decanoic, undecanoic, dodecanoic, tetradecanoic, hexadecanoic, octadecanoic, eicosanoic, docosanoic, acrylic, methacrylic, crotonic, undecenoic, octadecenoic, cyclohexanecarboxylic, cyclohexane-acetic, benzoic, methylbenzoic, t-butylbenzoic, methoxybenzoic, hydroxybenzoic, 3,5-di-t-butyl-4-hydroxybenzoic, phenylacetic, phenoxyacetic, 3-phenylpropionic, 3-(3,5-di-t-butyl-4-hydroxyphenyl)-propionic, furoic, tetrahydrofurancarboxylic, nicotinic, isonicotinic, pyroglutamic, 3-(2,2,6,6-tetramethyl-4-piperidylamino)crotonic, etc.

Examples of alkylene groups having not more than 12 carbon atoms are: methylene, ethylene, propylene, trimethylene, tetramethylene, pentamethylene, 2,2-trimethyltrimethylene, hexamethylene, heptamethylene, octamethylene, trimethylhexamethylene, decamethylene, dodecamethylene, etc.

Examples of C₄-C₁₂ alkylene groups interrupted by 1, 2 or 3 oxygen atoms are: 3-oxapentane-1,5-diyl, 4-oxaheptane-1,7-diyl, 3,6-dioxa-octane-1,8-diyl, 4,7-dioxadecane-1,10-diyl, 4,9-dioxadodecane-1,12-diyl, 3,6,9-trioxaundecane-1,11-diyl, 4,7,10-trioxadecane-1,13-diyl, etc.

Examples of diacyl-aliphatic, cycloaliphatic, aromatic, arylaliphatic or heterocyclic groups having not more than 22 carbon atoms are those deriving from the following acids: oxalic, malonic, succinic, methylmalonic, allylmalonic, glutaric, ethylmalonic, adipic, pimelic, diethylmalonic, suberic, azelaic, sebacic, 1,12-dodecanoic, oxydiacetic, iminodiacetic, methyliminodiacetic, maleic, fumaric, itaconic, citraconic, cyclohexanedicarboxylic, cyclohexenedicarboxylic, bicycloheptenedicarboxylic, phthalic, isophthalic, terephthalic, phenylmalonic, benzylidenemalonic, benzylmalonic, butyl-3,5-di-t-butyl-4-hydroxybenzylmalonic, furandicarboxylic, pyridinedicarboxylic, 1,4-dioxaspiro[4.5]decane-2,3-dicarboxylic, 1,5-dioxaspiro[5.5]undecane-3,3-dicarboxylic, 7,7,9,9-tetramethyl-1,4-dioxa-8-azaspiro[4.5]decane-2,3-dicarboxylic, 8,8,10,10-tetramethyl-1,5-dioxa-9-azaspiro[5.5]undecane-3,3-dicarboxylic, N-(2,2,6,6-tetramethyl-4-piperidyl)iminodiacetic, etc.

Examples of triacyl-aliphatic, aromatic or heterocyclic groups having not more than 18 carbon atoms are those deriving from the following acids: methanetricarboxylic, 1,1,2-ethanetricarboxylic, 1,2,3-propanetricarboxylic, 1,2,3-butanetricarboxylic, citric, nitrilotriacetic, benzenetricarboxylic, or from the acid having the formula:

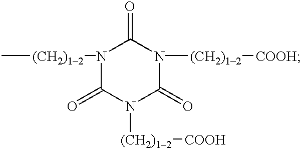

etc.

Examples of tetra-acyl-aliphatic or aromatic groups having not more than 18 carbon atoms are those deriving from the following acids: 1,1,2,2-ethanetetracarboxylic, 1,1,3,3-propanetetracarboxylic, 1,2,2,3-propanetetracarboxylic, 1,2,3,4-butanetetracarboxylic, ethylenediaminotetra-acetic, pyromellitic, etc.

Compounds belonging to the group of 3-pyrazolidinones (a) having general formula (I) or (II), of interest for the purposes of the present invention, are those wherein A₁ is a phenyl group, or a

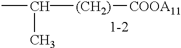

group, wherein A₁₁ is a linear or branched C₁₂-C₁₈ alkyl group; A₃, A₄, A₅ and A₆ are hydrogen; s is 1 or 2; when s is 1, A₂ is hydrogen, a linear or branched C₁-C₁₂ alkyl group, or a benzyl group; when s is 2, A₂ is a xylylene group; A₇ is a phenyl group; A₈ is a hydrogen or a methyl; t is 1 or 2; when t is 1, A₉ is a C₁₀-C₂₂ acylaliphatic group, a benzoyl group, or a group having general formula (IVa) or (IVb) wherein A₁₃ is a linear or branched C₁₂-C₁₈ alkyl group, A₁₄ is hydrogen, A₁₅ is a linear or branched C₁-C₄ alkyl group or a cyclohexyl group; when t is 2, A₉ is a —CO(CH₂)₂₋₈CO— group, or a group having general formula (Va) or (Vb) wherein A₁₉ is a linear or branched C₄-C₆ alkylene group and A₂₀ has the same meanings defined above.

Compounds belonging to the group of 3-pyrazolidinones (a) having general formula (I) or (II) of particular interest for the purposes of the present invention but in no way limiting its scope, are:

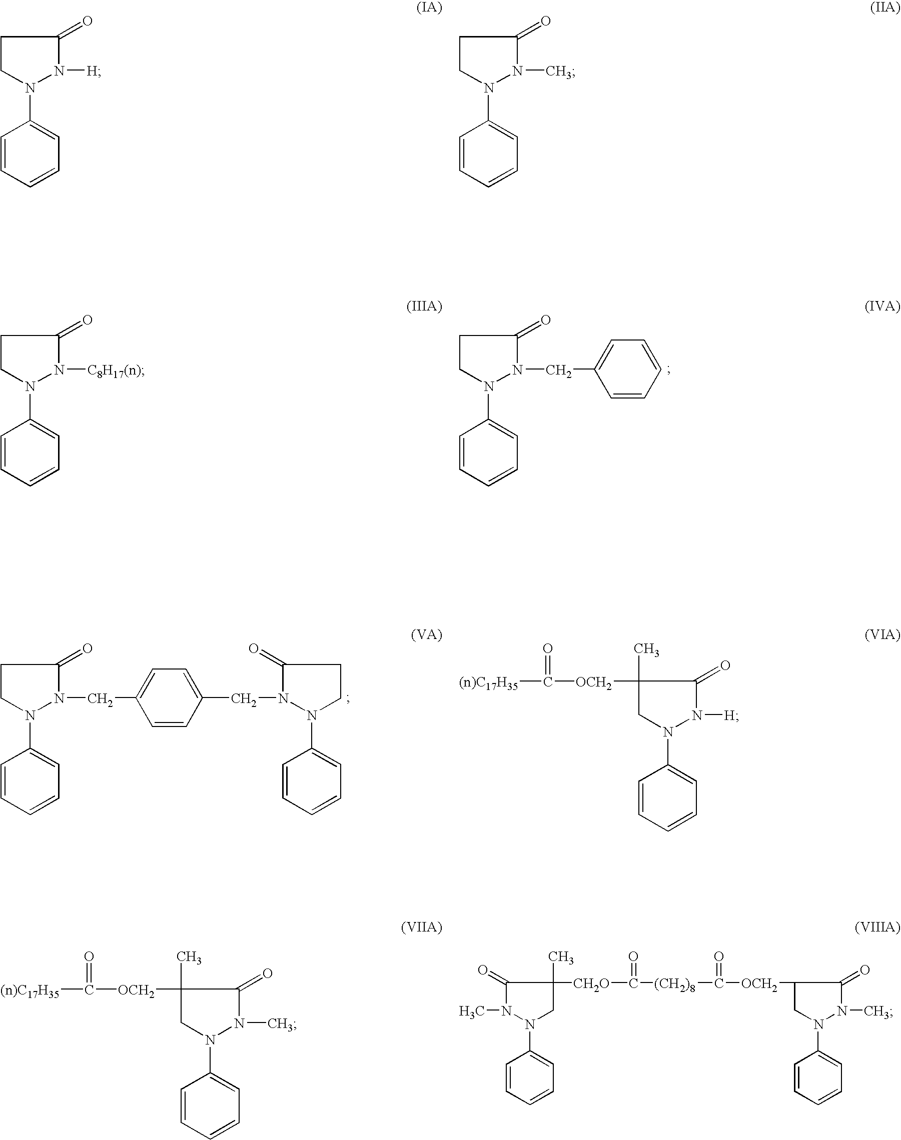

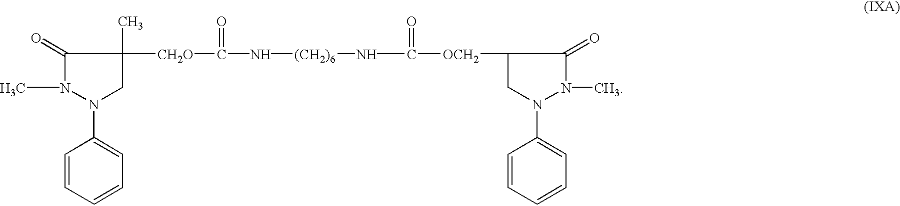

The compounds belonging to the group of 3-pyrazolidinones (a) having general formula (I) or (II) are known in the art: some are commercially available products, others can be prepared as described, for example, in “Tetrahedron Letters” (1985), Vol. 26, page 5663; or in the following patents: DE 53,834, GB 650,911, JP 11/060559 and U.S. Pat. No. 4,835,285.

Compounds belonging to the group of organic phosphites or phosphonites (b) useful for the purposes of the present invention are selected from those having the following general formulae (VI)-(XII):

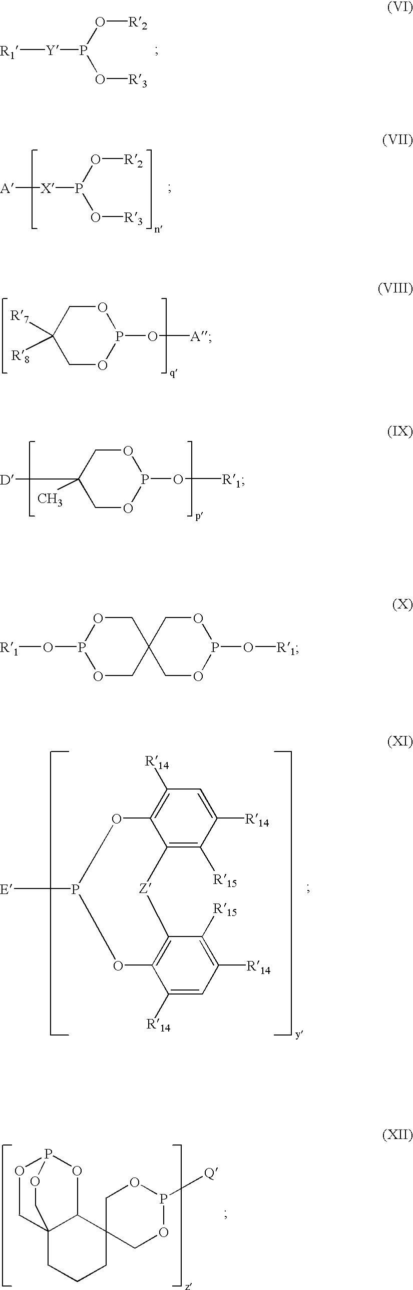

wherein:

n′ is 2, 3 or 4;

p′ is 1 or 2;

q′ is 2 or 3;

r′ is an integer ranging from 4 to 12, extremes included;

y′ is 1, 2 or 3;

z′ is an integer ranging from 1 to 6, extremes included;

when n′ is 2, A′ represents a C₂-C₁₈ alkylene group; a C₂-C₁₂ alkylene group containing an oxygen atom, a sulfur atom, or an —NR′₄— group; a group having general formula (XIII):

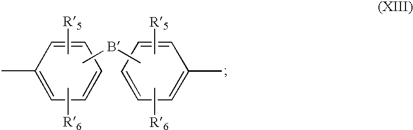

a group having general formula (XIV):

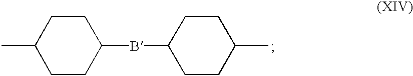

a phenylene group;

when n′ is 3, A′ represents a group having general formula —C_{r′}H_{2r′-1}— wherein r′ has the same values described above;

when n′ is 4, A′ represents a group having the formula:

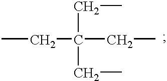

A″ has the same meanings defined above for A′ when n′ is 2;

B′ represents a direct bond; one of the following groups: —CH₂—, —CHR′₄—, —CR′₁R′₄—; a sulfur atom; a C₅-C₇ cycloalkylidene group; a cyclohexylidene group substituted with 1-4 C₁-C₄ alkyl groups in position 3, 4 and/or 5;

when p′ is 1, D′ represents a methyl group; and, when p′ is 2, D′ represents a —CH₂OCH₂— group;

when y′ is 1, E′ represents a C₁-C₁₈ alkyl group; an —OR′₁ group; a halogen atom;

when y′ is 2, E′ represents an —O—A″—O— group;

when y′ is 3, E′ represents one of the following groups: R′₄C(CH₂O—)₃, N(CH₂CH₂O—)₃;

Q′ represents a radical of an alcohol or a phenol with valence z′, said radical being attached to the phosphorous atom by means of an oxygen atom;

R′₁, R′₂ and R′₃, each independently, represent a hydrogen atom; a halogen atom; one of the following groups: —COOR′₄—, —CN—, —CONR′₄R′₄; a C₂-C₁₈ alkyl group containing an oxygen atom, a sulfur atom, an —NR′₄— group; a C₇-C₉ phenylalkyl group; a C₅-C₁₂ cycloalkyl group; a phenyl group or a naphthyl group, said phenyl or naphthyl groups optionally substituted with halogen atoms, or with 1-3 C₁-C₁₈ alkyl or alkoxyl groups or with C₇-C₉ phenylalkyl groups; or they represent a group having general formula (XV):

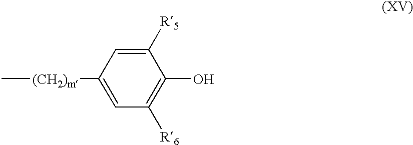

wherein m′ represents an integer ranging from 3 to 6, extremes included;

R′₄ represents a hydrogen atom; a C₁-C₁₈ alkyl group; a C₅-C₁₂ cycloalkyl group; a C₇-C₉ phenylalkyl group;

R′₅ and R′₆, each independently, represent a hydrogen atom; a C₁-C₈ alkyl group; a C₅-C₆ cycloalkyl group;

when q′ is 2, R′₇ and R′₈, each independently, represent a C₁-C₄ alkyl group; or, considered jointly, they represent a 2,3-dihydropentamethylene group;

when q′ is 3, R′₇ and R′₈ represent a methyl group;

R′₁₄ represents a hydrogen atom; a C₁-C₉ alkyl group; a cyclohexyl group;

R′₁₅ represents a hydrogen atom; a methyl group; or, when two or more R′₁₄ and R′₁₅ groups are present, said groups are the same as or different from each other;

X′ and Y′ represent a direct bond; an oxygen atom;

Z′ represents a direct bond; a methylene group; a —C(R′₁₆)₂— group; a sulfur atom;

R′₁₆ represents a C₁-C₈ alkyl group.

Compounds belonging to the group of organic phosphites or phosphonites (b) of particular interest for the purposes of the present invention are those having general formula (VI), (VII), (X) and (XI) wherein:

n′ is 2 and y′ is 1, 2 or 3;

A′ represents a C₂-C₁₈ alkylene group; a p-phenylene or p-bisphenylene group;

when y′ is 1, E′ represents a C₁-C₁₈ alkyl group; an —OR′— group, a fluorine atom;

when y′ is 2, E′ represents a p-bisphenylene group;

when y′ is 3, E′ represents an N(CH₂CH₂O—)₃ group;

R′₁, R′₂ and R′₃, each independently represent a C₁-C₁₈ alkyl group; a C₇-C₉ phenylalkyl group; a cyclohexyl group; a phenyl group; said phenyl group optionally substituted with 1-3 C₁-C₁₈ alkyl groups;

R′₁₄ represents a hydrogen atom; a C₁-C₉ alkyl group;

R′₁₅ represents a hydrogen atom; a methyl group;

X′ represents a direct bond;

Y′ represents an oxygen atom;

Z′ represents a direct bond; a —CH(R′₁₆)— group;

R′₁₆ represents a C₁-C₄ alkyl group.

Similarly, compounds belonging to the group of organic phosphites or phosphonites (b) of particular interest for the purposes of the present invention are those having general formula (VI), (VII), (X) and (XI) wherein:

n′ is 2 and y′ is 1 or 3;

A′ represents a p-bisphenylene group;

when y′ is 1, E′ represents a C₁-C₁₈ alkoxyl group; a fluorine atom;

when y′ is 3, E′ represents an N(CH₂CH₂O—)₃ group;

R′₁, R′₂ and R′₃, each independently, represent a C₁-C₁₈ alkyl group; a phenyl group substituted with 2-3 C₂-C₁₂ alkyl groups;

R′₁₄ represents a methyl group; a t-butyl group;

R′₁₅ represents a hydrogen atom;

X′ represents a direct bond;

Y′ represents an oxygen atom;

Z′ represents a direct bond; a methylene group; a —CH(CH₃)— group.

Preferred compounds belonging to the group of organic phosphites or phosphonites (b) for the purposes of the present invention are those having general formula (VI), (VII) and (XI); particularly preferred are those having general formula (XVI):

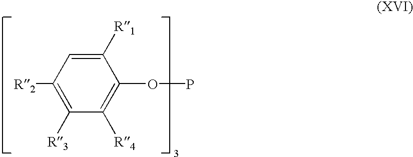

wherein:

R″₁, and R″₂, each independently, represent a hydrogen atom; a C₁-C₈ alkyl group; a cyclohexyl group; a phenyl group;

R″₃ and R″₄, each independently, represent a hydrogen atom; a C₁-C₄ alkyl group.

Specific examples of compounds belonging to the group of phosphites or phosphonites (b) useful for the purposes of the present invention are: triphenyl phosphite; diphenyl alkyl phosphites; phenyl dialkyl phosphites; tris(nonylphenyl)phosphite (known under the trade-name of Alkanox™ TNPP of Great Lakes Chemical Corporation); trilauryl phosphite; trioctadecyl phosphite; distearyl pentaerythritol diphosphite; tris(2,4-di-t-butylphenyl)phosphite (known under the trade-name of Alkanox™ 240 of Great Lakes Chemical Corporation); diisodecyl pentaerythritol diphosphite; bis(2,4-di-t-butylphenyl)pentaerythritol diphosphite (known under the trade-name of Alkanox™ P24 of Great Lakes Chemical Corporation); bis(2,6-di-t-butyl-4-methylphenyl)pentaerythritol diphosphite; bis-isodecyloxypentaerythritol diphosphite, bis(2,4-di-t-butyl-6-methylphenyl)pentaery- thritol diphosphite; bis(2,4,6-tris-t-butylphenyl)pentaerythritol diphosphite; tristearylsorbitol triphosphite; tetra-kis(2,4-di-t-butylphenyl)-4,4′-diphenylenediphosphonite (known under the trade-name of Alkanox™ 24-44 of Great Lakes Chemical Corporation); 6-iso-octyloxy-2,4,8,10-tetra-t-butyl-12H-dibenzo-[d,g]-1,3,2-dioxaphosphocine; 6-fluoro-2,4,8,10-tetra-t-butyl-12-methyldibenzo[d,g]-1,3,2-dioxaphosphocine; bis(2,4-di-t-butyl-6-methylphenyl)methyl phosphite; bis-(2,4-di-t-butyl-6-methylphenyl)ethyl phosphite (known under the trade-name of Irgafos® 38 of Ciba Specialty Chemicals); bis(2,4-dicumylphenyl)pentaerythritol diphosphite.

Specific examples of particularly preferred compounds belonging to the group of organic phosphites or phosphonites (b) for the purposes of the present invention are: tris(2,4-di-t-butylphenyl)phosphite (known under the trade-name of Alkanox™ 240 of Great Lakes Chemical Corporation); tris(nonylphenyl)phosphite (known under the trade-name of Alkanox™ TNPP of Great Lakes Chemical Corporation); 6-fluoro-2,4,8,10-tetra-t-butyl-12-methyldibenzo[d,g]-1,3,2-dioxaphosphocine; 6-iso-octyloxy-2,4,-8,10-tetra-t-butyl-12H-dibenzo-[d,g]-1,3,2-dioxaphosphocine; bis(2,4-di-t-butylphenyl)pentaerythritol diphosphite (known under the trade-name of Alkanox™ P24 of Great Lakes Chemical Corporation); bis(2,6-di-t-butyl-4-methylphenyl)pentaerythritol diphosphite; bis-(2,4-di-t-butyl-6-methylphenyl) ethyl phosphate (known under the trade-name of Irgafos® 38 of Ciba Specialty Chemicals); bis-(2,4-dicumylphenyl) pentaerythritol diphosphite; tetrakis(2,4-di-t-butylphenyl)-4,4′-diphenylenediphosphonite (known under the trade-name of Alkanox™ 24-44 of Great Lakes Chemical Corporation); triphosphite having formula (XVII):

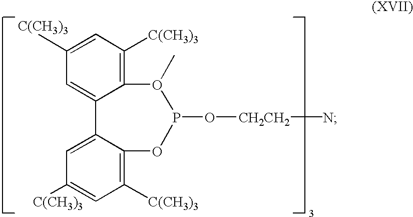

diphosphite having general formula (XVIII):

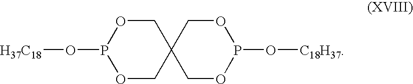

Specific examples of compounds belonging to the group of organic phosphites or phosphonites (b) even more preferred for the purposes of the present invention are: tris(2,4-di-t-butylphenyl)phosphite (known under the trade-name of Alkanox™ 240 of Great Lakes Chemical Corporation); bis-(2,4-di-t-butyl-6-methylphenyl)ethyl phosphite (known under the trade-name of Irgafos® 38 of Ciba Specialty Chemicals); tetrakis(2,4-di-t-butylphenyl)-4,4′-diphenylenediphosphonite (known under the trade-name of Alkanox™ 24-44 of Great Lakes Chemical Corporation); bis(2,4-dicumylphenyl)pentaerythritol diphosphite.

The compounds belonging to the group of organic phosphites or phosphonites (b) described above are known compounds; many of them are commercially available products.

Compounds belonging to the group of sterically hindered phenols (c) useful for the purposes of the present invention are selected from those having general formula (XIX):

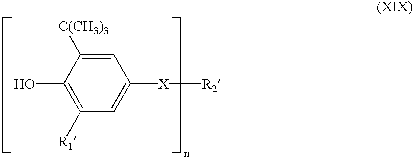

wherein:

R₁′ represents a C₁-C₄ alkyl group;

n is 1, 2, 3 or 4;

X represents a methylene group; or a group having general formula (XX) or (XXI):

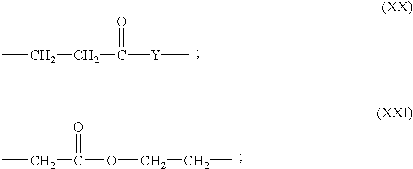

Y represents an oxygen atom; an —NH— group;

when n is 1, X represents a group having general formula (XX) wherein Y is attached to R₂′ and R₂′ represents a C₁-C₂₅ alkyl group;

when n is 2, X represents a group having general formula (XX) wherein Y is attached to R₂′ and R₂′ represents a C₂-C₁₂ alkylene group; a C₄-C₁₂ alkylene group containing one or more oxygen or sulfur atoms; or, when Y represents an —NH— group, R₂′ represents a direct bond;

when n is 3, X represents a methylene group; a group having general formula (XXI) wherein the ethylene group is bound to R₂′ and R₂′ represents a group having formula (XXII):

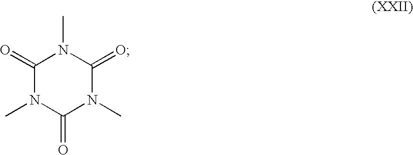

when n is 4, X represents a group having general formula (XX) wherein Y is bound to R₂′ and R₂′ represents a C₄-C₁₀ alkane-tetrayl group.

Examples of linear or branched alkyl groups having up to 25 carbon atoms are: methyl, ethyl, propyl, isopropyl, n-butyl, s-butyl, isobutyl, t-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or doicosyl, etc.

R₁′ preferably represents methyl or t-butyl.

R₂′ preferably represents a C₁-C₂₀ alkyl group, particularly a C₁-C₁₈ alkyl group, for example, a C₄-C₁₈ alkyl group. Even more preferably, R₂′ represents a C₈-C₁₈ alkyl group, particularly a C₁₄-C₁₈ alkyl group, for example octadecyl.

Examples of linear or branched C₂-C₁₂ alkylene groups, are: ethylene, propylene, tetramethylene, pentamethylene, hexamethylene, heptamethylene, octamethylene, decamethylene, dodecamethylene, etc.

R₂′ preferably represents a C₂-C₁₀ alkylene group, particularly a C₂-C₈ alkylene group. Even more preferably, R₂′ represents a C₄-C₈ alkylene group, particularly a C₄-C₆ alkylene group, for example hexamethylene.

Examples of C₄-C₁₂ alkylene groups containing one or more oxygen or sulfur atoms, are:

—CH₂—O—CH₂CH₂—O—CH₂—, —CH₂—(O—CH₂CH₂)₂—O—CH₂—,

—CH₂—(O—CH₂CH₂)₃—O—CH₂—, —CH₂—(O—CH₂CH₂)₄—O—CH₂—,

—CH₂—CH₂—O—CH₂CH₂—O—CH₂CH₂—, —CH₂—CH₂—S—CH₂CH₂—, etc.

R₂′ preferably represents a C₄-C₁₀ alkylene group containing one or more oxygen or sulfur atoms, particularly a C₄-C₈ alkylene group containing one or more oxygen or sulfur atoms, for example a C₄-C₆ alkylene group containing one or more oxygen or sulfur atoms. Even more preferably, R₂′ represents one of the following groups:

—CH₂—CH₂—O—CH₂CH₂—O—CH₂CH₂—, —CH₂—CH₂—S—CH₂CH₂—.

Examples of C₄-C₁₀ alkane-tetrayl groups are:

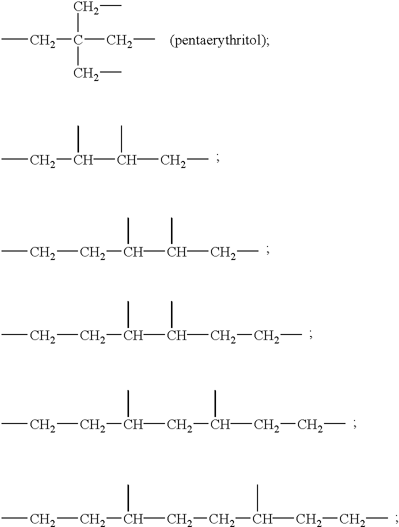

etc. Pentaerythritol is preferred.

Specific examples of compounds belonging to the group of sterically hindered phenols (c) useful for the purposes of the present invention are those wherein, in general formula (XIX), when n is 1, R₂′ represents a C₁-C₂₀ alkyl group.

Specific examples of preferred compounds belonging to the group of sterically hindered phenols (c) for the purposes of the present invention are those wherein, in general formula (XIX), when n is 2, R₂′ represents a C₂-C₈ alkylene group, or a C₄-C₈ alkylene group containing one or more oxygen or sulfur atoms; or, when Y represents an —NH— group, R₂′ represents a direct bond; and, when n is 4, R₂′ represents a C₄-C₈ alkane-tetrayl group.

Similarly, examples of preferred compounds belonging to the group of sterically hindered phenols (c) for the purposes of the present invention are those wherein, in general formula (XIX), R₁′ represents methyl or t-butyl; n is 1, 2 or 4; X represents a group having general formula (XX); Y represents an oxygen atom or an —NH— group; and, when n is 1, R₂′ represents a C₁₄-C₁₈ alkyl group; and, when n is 2, R₂′ represents a C₄-C₆ alkylene group, or a C₄-C₆ alkylene group containing one or more oxygen or sulfur atoms; and, when n is 4, R₂′ represents a C₄-C₆ alkane-tetrayl group.

Similarly, of interest for the purposes of the present invention are compounds belonging to the group of sterically hindered phenols (c) having general formula (XIX), selected from: N,N′-hexamethylene bis[3-(3,5-di-t-butyl-4-hydroxyphenyl)propionamide] (known under the trade-name of Lowinox® HD-98 of Great Lakes Chemical Corporation); octadecyl 3-(3′,5′-di-t-butyl-4′-hydroxyphenyl)propionate (known under the trade-name of Anox™ PP18 of Great Lakes Chemical Corporation); tetrakismethylene(3,5-di-t-butyl-4-hydroxy-hydrocinnamate)methane (known under the trade-name of Anox™ 20 of Great Lakes Chemical Corporation); triethylene glycol bis[3-(3-t-butyl-4-hydroxy-5-methylphenyl)propionate] (known under the trade-name of Lowinox® GP-45 of Great Lakes Chemical Corporation); 2,2′-thiodiethylene bis[3(3,5-di-t-butyl-4-hydroxyphe-nyl)propionate] (known under the trade-name of Anox™ 70 of Great Lakes Chemical Corporation); 1,3,5-tris(3,5-di-t-butyl-4-hydroxybenzyl)isocyanurate (known under the trade-name of Anox™ IC-14 of Great Lakes Chemical Corporation); the compound having the formula:

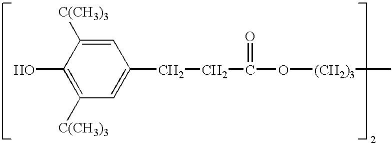

(known under the trade-name of Irganox® 259 of Ciba Specialty Chemicals); the compound having the formula:

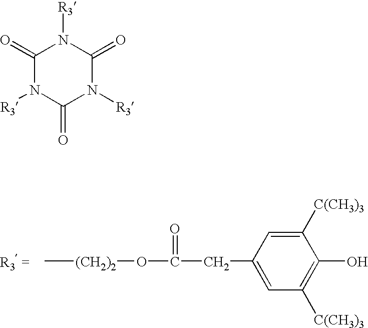

(known under the trade-name of Irganox® 3125 of Ciba Specialty Chemicals).

Also of interest for the purposes of the present invention are compounds belonging to the group of sterically hindered phenols (c) consisting of reactive antioxidant compounds containing a sterically hindered phenol group having general formula (I′) or (I′a):

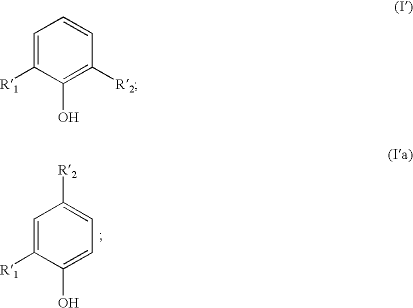

more specifically, reactive antioxidant compounds containing sterically hindered phenol groups having general formula (I′) or (I′a) useful for the purposes of the present invention, are selected from those having general formula (II′) or (II′a):

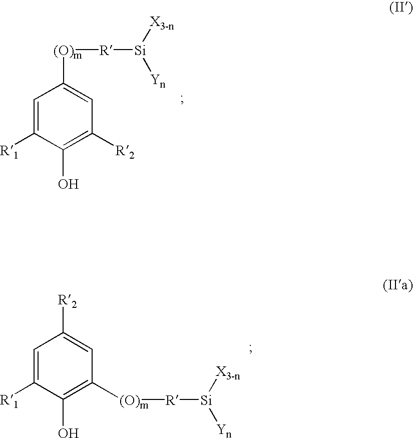

said reactive antioxidant compounds containing sterically hindered phenol groups having general formula (I′), (I′a), (II′) and (II′a), are described in European patents EP 162,523 and EP 182,415 which should be considered as forming an integrant part of the present patent application. The above reactive antioxidant compounds may produce complex resinous structures by means of hydrolysis and condensation of the hydrolyzable silicic function.

A specific example of the above reactive antioxidant compounds is the following compound having general formula (II″):

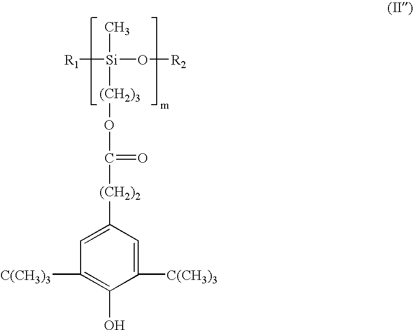

consisting of a mixture of linear oligomers wherein R₁=OH and R₂=H, and cyclic oligomers wherein R₁ and R₂ represent a direct bond, having a number average molecular weight equal to 3,900.

As said above, the compounds belonging to the sterically hindered phenols (c) group are known compounds and, in some cases, are commercially available. Or, said compounds, can be prepared according to processes described, for example, in patents U.S. Pat. No. 3,330,859, U.S. Pat. No. 3,960,928, or in European patents EP 162,523 and EP 182,415.

Compounds belonging to the group of sterically hindered amines (d) useful for the purposes of the present invention are selected from those comprising at least one group having general formula (XXIII) or (XXIV):

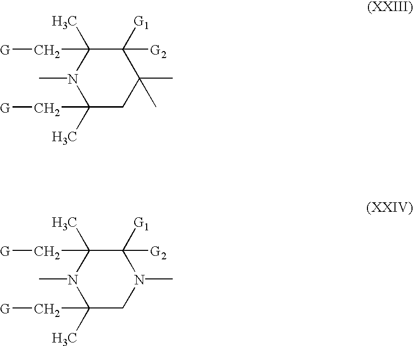

wherein:

G represents a hydrogen atom; or a methyl group;

G₁ and G₂, the same or different, represent a hydrogen atom; a methyl group; or, they jointly represent an oxygen atom.

Of particular interest for the purposes of the present invention are compounds belonging to the group of sterically hindered amines (d) selected from compounds (a′)-(h′) which comprise at least one group having general formula (XXIII) or (XXIV). (a′) Compounds having general formula (XXV):

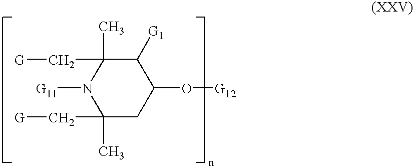

wherein n is a number ranging from 1 to 4, extremes included; G and G₁, independently represent a hydrogen atom or a methyl; G₁₁ represents a hydrogen atom, O, a hydroxyl group, an NO group, a —CH₂CN group, a C₁-C₁₈ alkyl group, a C₃-C₈ alkenyl group, a C₃-C₈ alkinyl group, a C₇-C₁₂ arylalkyl group, a C₁-C₁₈ alkoxyl group, a C₅-C₈ cycloalkoxyl group, a C₇-C₉ phenylalkoxyl group, a C₁-C₈ alkanoyl group, a C₃-C₅ alkenoyl group, a C₁-C₁₈ alkanoyloxyl group, a benzyloxyl group, a glycidyl group, an OG₁₁′ group, wherein G₁₁′ represents a linear or branched C₁-C₁₀ alkyl group; a —CH₂CH(OH)—Z group wherein Z represents a hydrogen atom, a methyl, or a phenyl, G₁₁ preferably being hydrogen, a C₁-C₄ alkyl group, an allyl, a benzyl, an acetyl or an acryloyl; G₁₂, when n is 1, represents a hydrogen atom, a C₁-C₁₈ alkyl group, said alkyl group optionally containing one or more oxygen atoms, a cyanoethyl group, a benzyl, a glycidyl group, a monovalent radical of a carboxylic acid, of a carbamic acid or of an acid containing phosphorous, aliphatic, cycloaliphatic or arylaliphatic, unsaturated or aromatic, or a monovalent silyl radical, preferably a radical of an aliphatic carboxylic acid having from 2 to 18 carbon atoms, of a cycloaliphatic carboxylic acid having from 7 to 15 carbon atoms, of an α,β-unsaturated carboxylic acid having from 3 to 5 carbon atoms, of an aromatic carboxylic acid having from 7 to 15 carbon atoms, said carboxylic acids optionally substituted in the aliphatic, cycloaliphatic or aromatic part, with 1-3 —COOZ₁₂ groups wherein Z₁₂ represents a hydrogen atom, a C₁-C₂₀ alkyl group, a C₃-C₁₂ alkenyl group, a C₅-C₇ cycloalkyl group, a phenyl or a benzyl; G₁₂, when n is 2, represents a C₂-C₁₂ alkylene group, a C₄-C₁₂ alkenylene group, a xylylene group, a divalent radical of a dicarboxylic acid, of a dicarbamic acid or of an acid containing phosphorous, aliphatic, cycloaliphatic, arylaliphatic or aromatic, or a divalent silyl radical, preferably a radical of an aliphatic dicarboxylic acid having from 2 to 36 carbon atoms, of a cycloaliphatic or aromatic dicarboxylic acid having from 8 to 14 carbon atoms, of an aliphatic, cycloaliphatic or aromatic dicarbamic acid, having from 8 to 14 carbon atoms, said dicarboxylic acids optionally substituted in the aliphatic, cycloaliphatic or aromatic part, with 1 or 2 —COOZ₁₂ groups wherein Z₁₂ has the same meanings defined above; G₁₂, when n is 3, represents a trivalent radical of an aliphatic, cycloaliphatic or aromatic tricarboxylic acid, optionally substituted in the aliphatic, cycloaliphatic or aromatic part, with a —COOZ₁₂ group wherein Z₁₂ has the same meanings defined above, or of an aromatic tricarbamic acid or of an acid containing phosphorous, or it represents a trivalent silyl radical; G₁₂, when n is 4, is a tetravalent radical of an aliphatic, cycloaliphatic or aromatic tetracarboxylic acid.

Radicals of tetracarboxylic acids comprise, in all cases, radicals having the formula (—CO)ₙR wherein n has the same meaning described above and R can be easily deduced from the above definition.

Examples of C₁-C₁₂ alkyl groups are: methyl, ethyl, n-propyl, n-butyl, s-butyl, t-butyl, n-hexyl, n-octyl, 2-ethylhexyl, n-nonyl, n-decyl, n-undecyl, n-dodecyl, etc.

Examples of G₁₁ and G₁₂ substituents, when they represent a C₁-C₁₈ alkyl group, are: in addition to the groups described above: n-tridecyl, n-tetradecyl, n-hexadecyl, n-octadecyl, etc.

Examples of the G₁₁ substituent, when it represents a C₃-C₈ alkenyl group, are: 1-propenyl, allyl, methallyl, 2-butenyl, 2-pentenyl, 2-hexenyl, 2-octenyl, 4-t-butyl-2-butenyl, etc.

When the G₁₁ substituent represents a C₃-C₈ alkinyl group, it is preferably propargyl.

When the G₁₁ substituent represents a C₇-C₁₂ arylalkyl group, it is, in particular, phenethyl, preferably benzyl.

Examples of the G₁₁ substituent, when it represents a C₁-C₈ alkanoyl group, are: formyl, propionyl, butyryl, octanoyl, preferably acetyl and, when it represents a C₃-C₅ alkenoyl group, preferably acryloyl.

Examples of the G₁₂ substituent, when it represents a monovalent radical of a carboxylic acid, are radicals of the following acids: acetic, caproic, stearic, acrylic, methacrylic, benzoic, β-(3,5-di-t-butyl-4-hydroxyphenyl)propionic, etc.

An example of the G₁₂ substituent, when it represents a monovalent silyl radical, is: a radical having general formula —(CⱼH₂ⱼ)—Si(Z′)₂Z″ wherein j is an integer ranging from 2 to 5, extremes included, and Z′ and Z″, each independently, represent a C₁-C₄ alkyl group or a C₁-C₄ alkoxyl group.

Examples of the G₁₂ substituent, when it represents a divalent radical of a dicarboxylic acid, are radicals of the following acids: malonic, succinic, glutaric, adipic, suberic, sebacic, maleic, itaconic, phthalic, dibutylmalonic, dibenzylmalonic, butyl(3,5-di-t-butyl-4-hydroxybenzyl)malonic, bicycloheptenedicarboxylic, etc.

Examples of the G₁₂ substituent, when it represents a trivalent radical of a tricarboxylic acid, are radicals of the acids: trimellitic, citric, nitrilotriacetic, etc.

Examples of the G₁₂ substituent, when it represents a tetravalent radical of a tetracarboxylic acid, are radicals of the following acids: butane-1,2,3,4-tetracarboxylic, pyromellitic, etc.

Examples of the G₁₂ substituent, when it represents a divalent radical of a dicarbamic acid, are radicals of the following acids: hexamethylenedicarbamic, 2,4-toluylenedicarbamic, etc.

Compounds having general formula (XXV) wherein G represents a hydrogen atom, G₁₁ represents a hydrogen atom or a methyl, n is 2 and G₁₂ represents a diacyl radical of an aliphatic dicarboxylic acid having from 4 to 12 carbon atoms, are preferred.

Specific examples of polyalkylpiperidines having general formula (XXV) are:

1) 4-hydroxy-2,2,6,6-tetramethylpiperidine;

2) 1-allyl-4-hydroxy-2,2,6,6-tetramethylpiperidine;

3) 1-benzyl-4-hydroxy-2,2,6,6-tetramethylpiperidine;

4) 1-(4-t-butyl-2-butenyl)-4-hydroxy-2,2,6,6-tetramethylpiperidine;

5) 4-stearyloxy-2,2,6,6-tetramethylpiperidine;

6) 1-ethyl-4-salicyloyloxy-2,2,6,6-tetramethylpiperidine;

7) 4-methacryloyloxy-1,2,2,6,6-pentamethylpiperidine;

8) 1,2,2,6,6-pentamethylpiperidin-4-yl-β-(3,5-di-t-butyl-4-hydroxyphenyl)propionate;

9) di(1-benzyl-2,2,6,6-tetramethylpiperidin-4-yl)maleate;

10) di(2,2,6,6-tetramethylpiperidin-4-yl)succinate;

11) di(2,2,6,6-tetramethylpiperidin-4-yl)glutarate;

12) di(2,2,6,6-tetramethylpiperidin-4-yl)adipate;

13) di(2,2,6,6-tetramethylpiperidin-4-yl)sebacate;

14) di(1,2,2,6,6-pentamethylpiperidin-4-yl)sebacate;

15) di(1,2,3,6-tetramethyl-2,6-diethylpiperidin-4-yl)sebacate;

16) di(1-allyl-2,2,6,6-tetramethylpiperidin-4-yl)phthalate;

17) 1-hydroxy-4-β-cyanoethyloxy-2,2,6,6-tetramethylpiperidine;

18) (1-acetyl-2,2,6,6-tetramethylpiperidin-4-yl)acetate;

19) tris(2,2,6,6-tetramethylpiperidin-4-yl)trimellitate;

20) 1-acryloyl-4-benzyloxy-2,2,6,6-tetramethylpiperidine;

21) di(2,2,6,6-tetramethylpiperidin-4-yl)diethylmalonate;

22) di(1,2,2,6,6-pentamethylpiperidin-4-yl)dibutylmalonate;

23) di(1,2,2,6,6-pentamethylpiperidin-4-yl)butyl-(3,5-di-tert-butyl-4-hydroxybenzyl)malonate;

24) di(1-octyloxy-2,2,6,6-tetramethylpiperidin-4-yl)sebacate;

25) di(1-cyclohexyloxy-2,2,6,6-tetramethylpiperidin-4-yl)sebacate;

26) hexane-1′,6′-bis(4-carbamoyloxy-1-n-butyl-2,2,6,6-tetramethylpiperidine);

27) toluene-2′,4′-bis(4-carbamoyloxy-1-n-propyl-2,2,6,6-tetramethylpiperidine);

28) dimethyl-bis(2,2,6,6-tetramethylpiperidin-4-oxy)silane;

29) phenyl-tris(2,2,6,6-tetramethylpiperidin-4-oxy)silane;

30) tris(1-propyl-2,2,6,6-tetramethylpiperidin-4-yl)phosphite;

31) tris(1-propyl-2,2,6,6-tetramethylpiperidin-4-yl)phosphate;

32) bis(1,2,2,6,6-pentamethylpiperidin-4-yl)phenylphosphonate;

33) 4-hydroxy-1,2,2,6,6-pentamethylpiperidine;

34) 4-hydroxy-N-hydroxyethyl-2,2,6,6-tetramethylpiperidine;

35) 4-hydroxy-N-(2-hydroxypropyl)-2,2,6,6-tetramethylpiperidine;

36) 1-glycidyl-4-hydroxy-2,2,6,6-tetramethylpiperidine.

(b′) Compounds having general formula (XXVI):

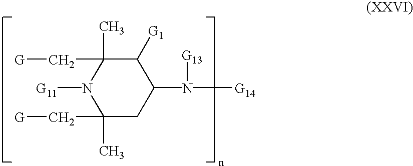

wherein n is 1 or 2; G, G₁ and G₁₁ have the same meanings described above under point (a′); G₁₃ represents a hydrogen atom, a C₁-C₁₂ alkyl group, a C₂-C₅ hydroxyalkyl group, a C₅-C₇ cycloalkyl group, a C₇-C₈ arylalkyl group, a C₂-C₁₈ alkanoyl group, a C₃-C₅ alkenoyl group, a benzoyl group, or a group having the following general formula:

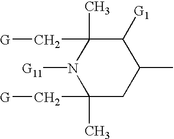

wherein G, G₁ and G₁₁ have the same meanings defined above under point (a′); G₁₄, when n is 1, represents a hydrogen atom, a C₁-C₁₈ alkyl group, a C₃-C₈ alkenyl group, a C₅-C₇ cycloalkyl group, a C₁-C₄ alkyl group substituted with a hydroxyl group, with a cyano group, with an alkoxycarbonyl group or with a carbamide group, a glycidyl group, a group having the formula —CH₂—CH(OH)—Z or a group having the formula —CONH—Z wherein Z represents a hydrogen atom, a methyl or a phenyl; G₁₄, when n is 2, represents a C₂-C₁₂ alkylene group, a C₆-C₁₂ arylene group, a xylylene group, a group having the formula —CH₂—CH(OH)—CH₂— or a group having the formula —CH₂—CH(OH)—CH₂—O—D—O wherein D represents a C₂-C₁₀ alkylene group, a C₆-C₁₅ arylene group, a C₆-C₁₂ cycloalkylene group; or, on the condition that G₁₃ does not represent an alkanoyl group, an alkenoyl group or a benzoyl group, G₁₄ can also represent a 1-oxo-(C₂-C₁₂)-alkylene group, a divalent radical of a dicarboxylic acid or of a dicarbamic acid, aliphatic, cycloaliphatic or aromatic, or also a —CO— group; or, when n is 1, G₁₃ and G₁₄ considered jointly, can also represent a divalent radical of a 1,2- or 1,3-dicarboxylic acid, aliphatic, cycloaliphatic or aromatic.

The C₁-C₁₂ alkyl or C₁-C₁₈ alkyl groups have already been described above under point (a′).

The C₅-C₇ cycloalkyl groups are preferably cyclohexyl.

When G₁₃ represents a C₇-C₈ arylalkyl group, it is phenylethyl, preferably benzyl.

When G₁₃ represents a C₂-C₅ hydroxyalkyl group, it is 2-hydroxyethyl, 2-hydroxypropyl, etc.

Examples of G₁₃, when it represents a C₂-C₁₈ alkanoyl group, are: propionyl, butyryl, octanoyl, dodecanoyl, hexadecanoyl, octadecanoyl, etc. preferably acetyl and, when it represents a C₃-C₅ alkenoyl group, it is preferably acryloyl.

Examples of G₁₄, when it represents a C₂-C₈ alkenyl group, are: allyl, methallyl, 2-butenyl, 2-pentenyl, 2-hexenyl, 2-octenyl, etc.

Examples of G₁₄, when it represents a C₁-C₄ alkyl group substituted by a hydroxyl, cyano, alkoxycarbonyl or carbamide group, are: 2-hydroxyethyl, 2-hydroxypropyl, 2-cyanoethyl, methoxycarbonylmethyl, 2-ethoxycarbonylethyl, 2-aminocarbonylpropyl, 2-(dimethylaminocarbonyl)ethyl, etc.

Examples of C₂-C₁₂ alkylene groups, are: ethylene, propylene, 2,2-dimethylpropylene, tetramethylene, hexamethylene, octamethylene, decamethylene, dodecamethylene, etc.

Examples of C₆-C₁₅ arylene groups, are: o-, m- or p-phenylene, 1,4-naphthylene, 4,4′-diphenylene, etc.

An example of a C₆-C₁₂ cycloalkylene group is preferably cyclohexylene.

Preferred compounds having general formula (XXVI) are those wherein n is 1 or 2, G represents a hydrogen atom, G₁₁ represents a hydrogen atom or a methyl, G₁₃ represents a hydrogen atom, a C₁-C₁₂ alkyl group or a group having the formula:

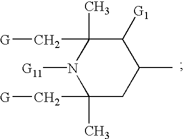

and G₁₄, when n is 1, represents a hydrogen atom or a C₁-C₁₂ alkyl group and, when n is 2, it represents a C₂-C₈ alkylene group or a 1-oxo-(C₂-C₈)-alkylene group.

Specific examples of polyalkylpiperidines having general formula (XXVI) are:

1) N,N′-bis(2,2,6,6-tetramethylpiperidin-4-yl)hexamethylene-1,6-diamine;

2) N,N′-bis(2,2,6,6-tetramethylpiperidin-4-yl)hexamethylene-1,6-diacetamide;

3) bis(2,2,6,6-tetramethylpiperidin-4-yl)amine;

4) 4-benzoylamino-2,2,6,6-tetramethylpiperidine;

5) N,N′-bis(2,2,6,6-tetramethylpiperidin-4-yl)-N,N′-dibutyladipamide;

6) N,N′-bis(2,2,6,6-tetramethylpiperidin-4-yl)-N,N′-dicyclohexyl-2-hydroxypropylene-1,3-diamine;

7) N,N′-bis(2,2,6,6-tetramethylpiperidin-4-yl)-p-xylylenediamine;

8) N,N′-bis(2,2,6,6-tetramethylpiperidin-4-yl)succinamide;

9) bis(2,2,6,6-tetramethylpiperidin-4-yl)-N-(2,2,6,6-tetramethylpiperidin-4-yl)-β-aminodipropionate;

10) compound having the formula:

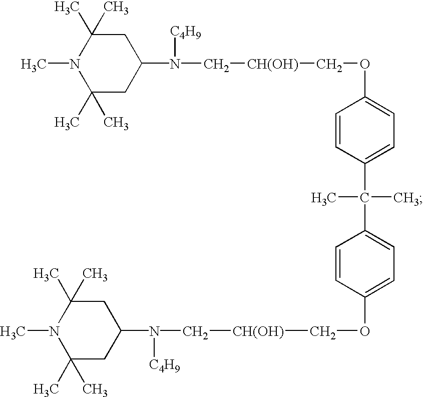

11) 4-[bis(2-hydroxyethyl)amino]-1,2,2,6,6-pentamethylpiperidine;

12) 4-(3-methyl-4-hydroxy-5-tert-butylbenzamide)-2,2,6,6-tetramethylpiperidine;

13) 4-methacrylamide-1,2,2,6,6-pentamethylpiperidine;

(c′) Compounds having general formula (XXVII):

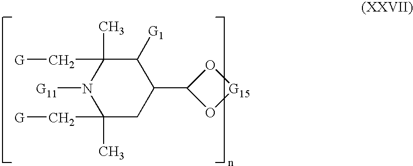

wherein n is 1 or 2; G, G₁ and G₁₁ have the same meanings described above under point (a′); G₁₅, when n is 1, represents a C₂-C₈ alkylene or hydroxyalkylene group, or a C₄-C₂₂ acyloxyalkylene group, and, when n is 2, it is a (—CH₂)₂C(CH₂—)₂ group.

Examples of G₁₅, when it represents a C₂-C₈ alkylene or hydroxyalkylene group, are: ethylene, 1-methylethylene, propylene, 2-ethylpropylene, 2-ethyl-2-hydroxymethyl-propylene, etc.

An example of G₁₅, when it represents a C₄-C₂₂ acyloxyalkylene group is 2-ethyl-2-acetoxy-methylpropylene.

Specific examples of polyalkylpiperidines having general formula (XXVII) are:

1) 9-aza-8,8,10,10-tetramethyl-1,5-dioxaspiro[5.5]undecane;

2) 9-aza-8,8,10,10-tetramethyl-3-ethyl-1,5-dioxaspiro[5.5]undecane;

3) 8-aza-2,7,7,8,9,9-hexamethyl-1,4-dioxaspiro[4.5]decane;

4) 9-aza-3-hydroxymethyl-3-ethyl-8,8,9,10,10-pentamethyl-1,5-dioxaspiro-[5.5]undecane;

5) 9-aza-3-ethyl-3-acetoxymethyl-9-acetyl-8,8,10,10-tetramethyl-1,5-dioxaspiro[5.5]undecane;

6) 2,2,6,6-tetramethylpiperidine-4-spiro-2′-(1′,3′-dioxane)-5′-spiro-5″-(1″,3″-dioxane)-2″-spiro-4′″-(2′″,2′″,6′″,6′″-tetramethylpiperidine).

(d′) Compounds having general formula (XXVIIIA), (XXVIIIB) and (XXVIIIC), compounds having general formula (XXVIIIC) being preferred:

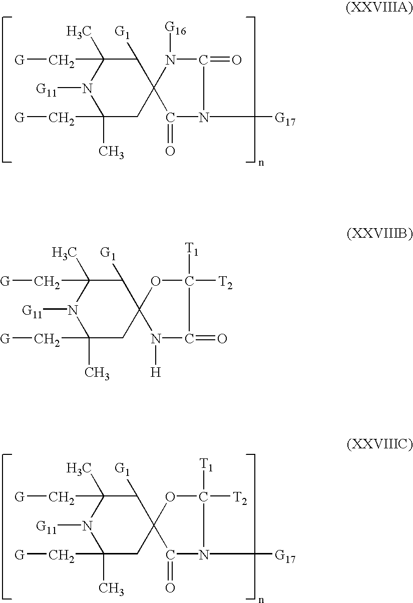

wherein n is 1 or 2, G, G₁ and G₁₁ have the same meanings defined above under point (a′); G₁₆ represents a hydrogen atom, a C₁-C₁₂ alkyl group, an allyl group, a benzyl, a glycidyl group or a C₂-C₆ alkoxyalkyl group; G₁₇, when n is 1, represents a hydrogen atom, a C₁-C₁₂ alkyl group, a C₃-C₅ alkenyl group, a C₇-C₉ arylalkyl group, a C₅-C₇ cycloalkyl group, a C₂-C₄ hydroxyalkyl group, a C₂-C₆ alkoxyl group, a C₆-C₁₀ aryl group, a glycidyl group, or a group having the formula —(CH₂)ₚ—COO—Q or —(CH₂)ₚ—O—CO—Q wherein p is 1 or 2 and Q represents a C₁-C₄ alkyl group or a phenyl; G₁₇, when n is 2, represents a C₂-C₁₂ alkylene group, a C₄-C₁₂ alkenylene group, a C₆-C₁₂ arylene group, a group having the formula:

—CH₂—CH(OH)—CH₂—O—D—O—CH₂—CH(OH)—CH₂— wherein D represents a C₂-C₁₀ alkylene group, a C₆-C₁₅ arylene group, a C₆-C₁₂ cycloalkylene group, or a group having the formula: —CH₂CH(OZ′)CH₂—(OCH₂—CH(OZ′)CH₂)₂ wherein Z′ represents a hydrogen atom, a C₁-C₁₈ alkyl group, an allyl, a benzyl, or a C₂-C₁₂ alkanoyl group or a benzoyl; T₁ and T₂ each independently represent a hydrogen atom, a C₁-C₁₈ alkyl group, a C₆-C₁₀ aryl group, a C₇-C₉ arylalkyl group, said groups optionally substituted with a halogen atom or with a C₁-C₄ alkyl group; or T₁ and T₂, considered jointly with the carbon atom to which they are bound, form a C₅-C₁₄ cyloalkane ring.

Examples of C₁-C₁₂ alkyl groups are: methyl, ethyl, n-propyl, n-butyl, s-butyl, t-butyl, n-hexyl, n-octyl, 2-ethylhexyl, n-nonyl, n-decyl, n-undecyl, n-dodecyl, etc.

Examples of C₁-C₁₈ alkyl groups are, in addition to those listed above: n-tridecyl, n-tetradecyl, n-hexadecyl, n-octadecyl, etc.

Examples of C₂-C₆ alkoxyalkyl groups are: methoxymethyl, ethoxymethyl, propoxymethyl, t-butoxymethyl, ethoxyethyl, ethoxypropyl, n-butoxyethyl, t-butoxyethyl, isopropoxyethyl, propoxypropyl, etc.

Examples of G₁₇, when it represents a C₃-C₅ alkenyl group are: 1-propenyl, allyl, methallyl, 2-butenyl, 2-pentenyl, etc.

Examples of G₁₇, T₁ and T₂, when they represent a C₇-C₉ arylalkyl group are: phenethyl, preferably benzyl.

Examples of cycloalkane rings, formed by T₁ and T₂ when said substituents are considered jointly with the carbon atom to which they are bound, are: cyclopentane, cyclohexane, cyclo-octane, cyclododecane, etc.

Examples of G₁₇, when it represents a C₂-C₄ hydroxyalkyl group, are: 2-hydroxyethyl, 2-hydroxypropyl, 2-hydroxybutyl, 4-hydroxybutyl, etc.

Examples of G₁₇, T₁ and T₂, when they represent a C₆-C₁₀ aryl group are: phenyl, α- or β-naphthyl, optionally substituted with a halogen atom or a C₁-C₄ alkyl group, etc.

Examples of G₁₇, when it represents a C₂-C₁₂ alkylene group, are: ethylene, propylene, 2,2-dimethylpropylene, tetramethylene, hexamethylene, octamethylene, decamethylene, dodecamethylene, etc.

Examples of G₁₇, when it represents a C₄-C₁₂ alkenylene group, are: 2-butenylene, 2-pentenylene, 3-hexenylene, etc.

Examples of G₁₇, when it represents a C₆-C₁₂ arylene group, are: o-, m- or p-phenylene, 1,4-naphthylene, 4,4′-diphenylene, etc.

Examples of Z′, when it represents a C₂-C₁₂ alkanoyl group, are: propionyl, butyryl, octanoyl, dodecanoyl, preferably acetyl.

Examples of D, when it represents a C₂-C₁₀ alkylene group, a C₆-C₁₅ arylene group or C₆-C₁₂ cycloalkylene group, are described above relating to point (b′).

Specific examples of polyalkylpiperidines having general formula (XXVIIIA), (XXVIIIB) and (XXVIIIC) are:

1) 3-benzyl-1,3,8-triaza-7,7,9,9-tetramethylspiro[4.5]-decane-2,4-dione;

2) 3-n-octyl-1,3,8-triaza-7,7,9,9-tetramethylspiro[4.5]-decane-2,4-dione;

3) 3-allyl-1,3,8-triaza-1,7,7,9,9-pentamethylspiro[4.5]-decane-2,4-dione;

4) 3-glycidyl-1,3,8-triaza-7,7,8,9,9-pentamethylspiro[4.5]-decane-2,4-dione;

5) 1,3,7,7,8,9,9-heptamethyl-1,3,8-triazaspiro[4.5]-decane-2,4-dione;

6) 2-isopropyl-7,7,9,9-tetramethyl-1-oxa-3,8-diaza-4-oxospiro[4.5]decane;

7) 2,2-dibutyl-7,7,9,9-tetramethyl-1-oxa-3,8-diaza-4-oxospiro[4.5]decane;

8) 2,2,4,4-tetramethyl-7-oxa-3,20-diaza-21-oxodispiro-[5.1.11.2]heneicosane;

9) 2-butyl-7,7,9,9-tetramethyl-1-oxa-4,8-diaza-3-oxo-spiro[4.5]decane; and, preferably,

10) 8-acetyl-3-dodecyl-1,3,8-triaza-7,7,9,9-tetramethylspiro[4.5]-decane-2,4-dione;

or a compound having one of the following formulae:

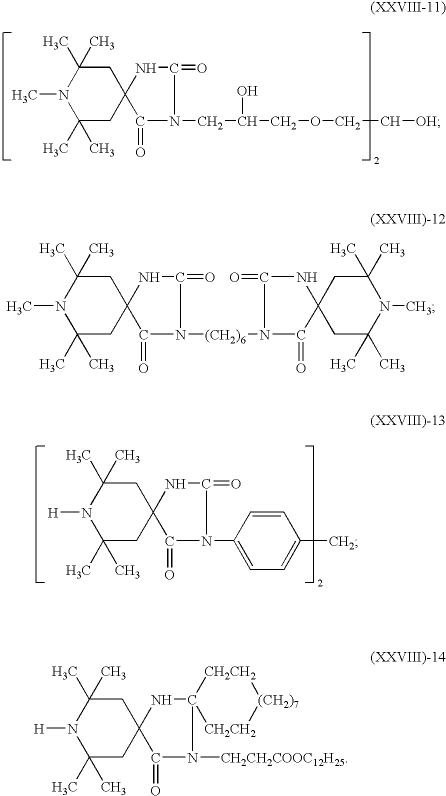

(e′) Compounds having general formula (XXIX):

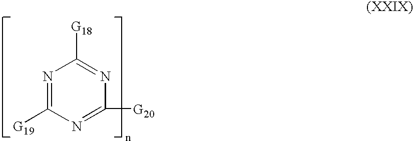

wherein n is 1 or 2, and G₁₈ represents a group having one of the following formulae:

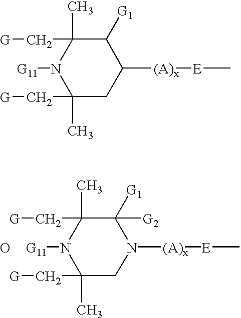

wherein G and G₁₁ have the same meanings defined above under point (a′); G₁ and G₂ represent a hydrogen atom, a methyl, or, considered jointly, they form a substituent ═O, E represents —O— or —NG₁₃—; A represents a C₂-C₆ alkylene group or a —(CH₂)₃—O— group; x is 0 or 1; G₁₃ represents a hydrogen atom, a C₁-C₁₂ alkyl group, a C₂-C₅ hydroxyalkyl group, a C₅-C₇ cycloalkyl group; G₁₉ has the same meanings as G₁₈ or it represents one of the following groups: —NG₂₁G₂₂, —OG₂₃, —NHCH₂OG₂₃, or —N(CH₂OG₂₃)₂; G₂₀, when n is 1, has the same meanings as G₁₈, or G₁₉, if n is 2, it represents an —E—B—E— group wherein B represents a C₂₋C₈ alkylene group optionally interrupted by 1 or 2 —N(G₂₁)— groups; G₂₁ represents a C₁-C₁₂ alkyl group, a cyclohexyl group, a benzyl, a C₁-C₄ hydroxyalkyl group, or a group having the following general formula:

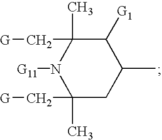

G₂₂ represents a C₁-C₁₂ alkyl group, a cyclohexyl group, a benzyl, a C₁-C₄ hydroxyalkyl group; G₂₃ represents a hydrogen atom, a C₁-C₁₂ alkyl group, a phenyl, or, G₂₁ and G₂₂, considered jointly, represent a C₄-C₅ alkylene or oxyalkylene group, for example:

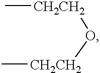

or a group having the formula:

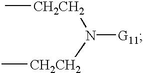

G₂₁ is a group having the general formula:

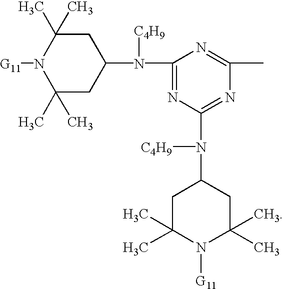

Examples of C₁-C₁₂ alkyl groups are: methyl, ethyl, n-propyl, n-butyl, s-butyl, t-butyl, n-hexyl, n-octyl, 2-ethylhexyl, n-nonyl, n-decyl, n-undecyl, n-dodecyl, etc.

Examples of C₁-C₄ hydroxyalkyl groups are: 2-hydroxyethyl, 2-hydroxypropyl, 3-hydroxypropyl, 2-hydroxybutyl, 4-hydroxybutyl, etc.

Examples of A, when it represents a C₂-C₆ alkylene group, are: ethylene, propylene, 2,2-dimethylpropylene, tetramethylene, hexamethylene, etc.

Examples of G₂₁ and G₂₂, when, considered jointly, they represent a C₄-C₅ alkylene or oxyalkylene group, are: tetramethylene, pentamethylene, 3-oxapentamethylene, etc.

Specific examples of polyalkylpiperidines having general formula (XXIX) are:

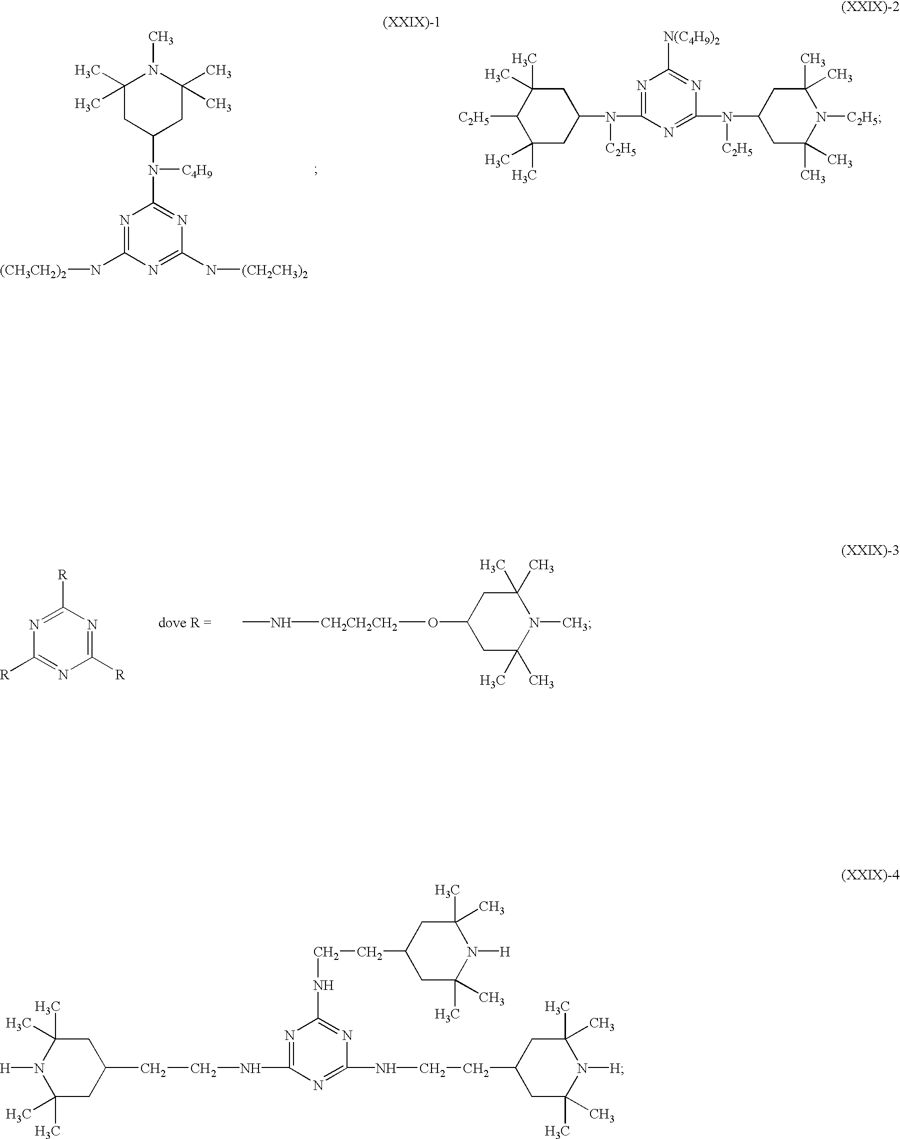

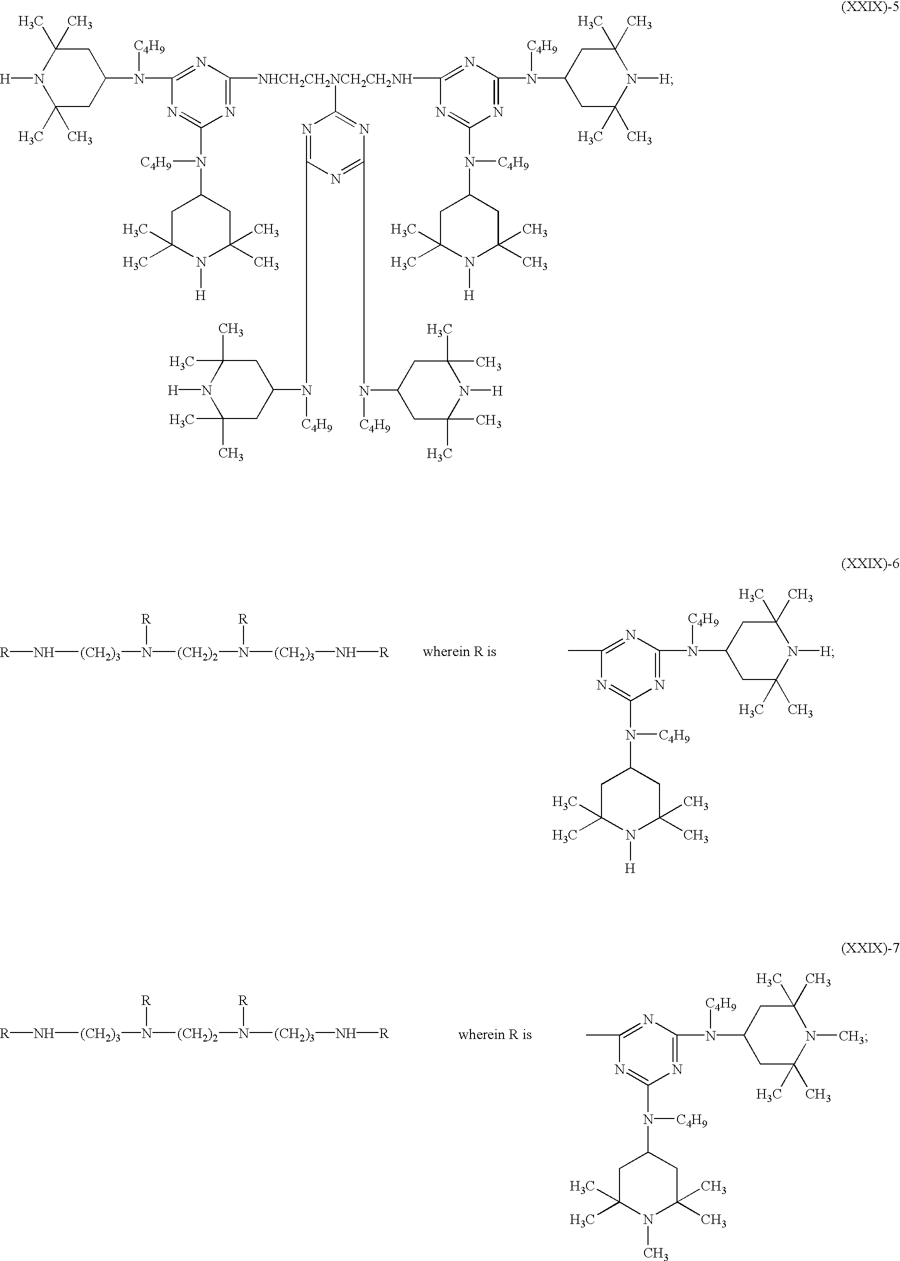

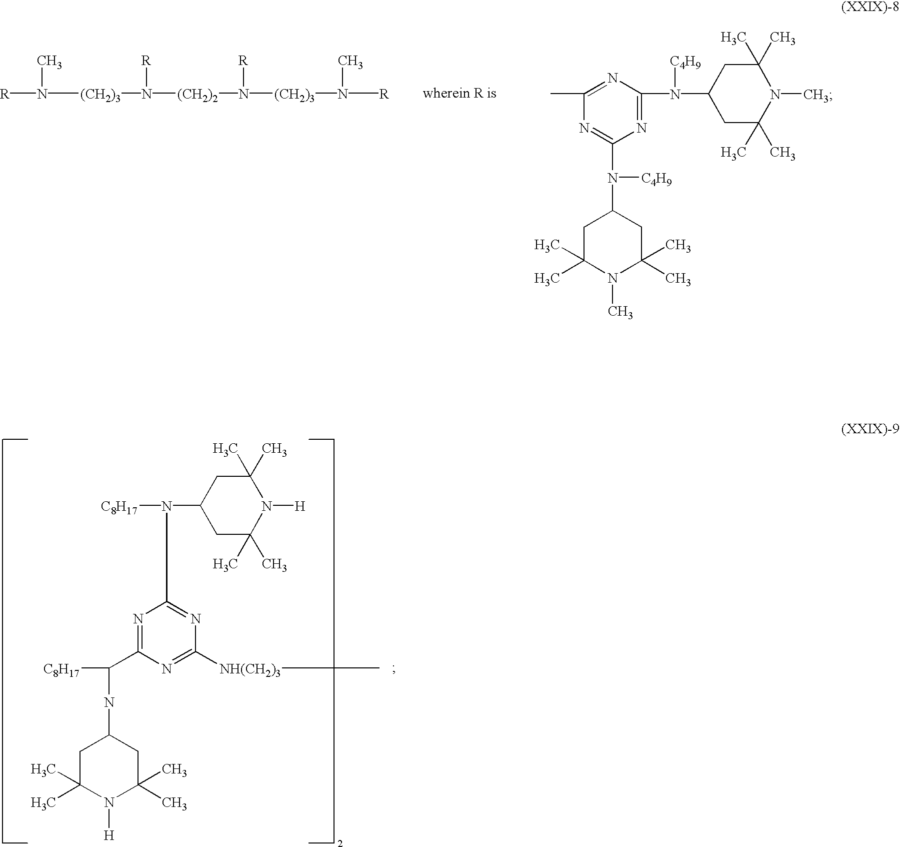

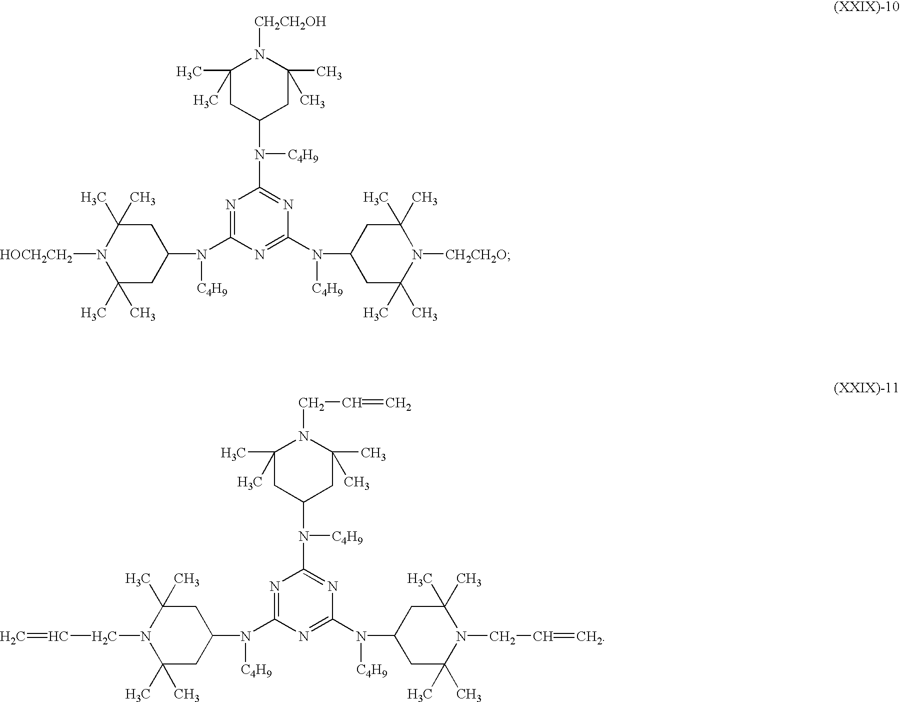

(f′) Oligomeric or polymeric compounds whose recurrent structural unit contains a 2,2,6,6-tetramethylpiperidine radical, in particular polyesters, polyethers, polyamides, polyamines, polyurethanes, polyureas, polyaminotriazines, poly(meth)acrylates, poly(meth)acrylamides, and their copolymers containing said radical.

Specific examples of the above 2,2,6,6-polyalkylpiperidines are represented by the following formulae wherein m is a number ranging from 2 to 200:

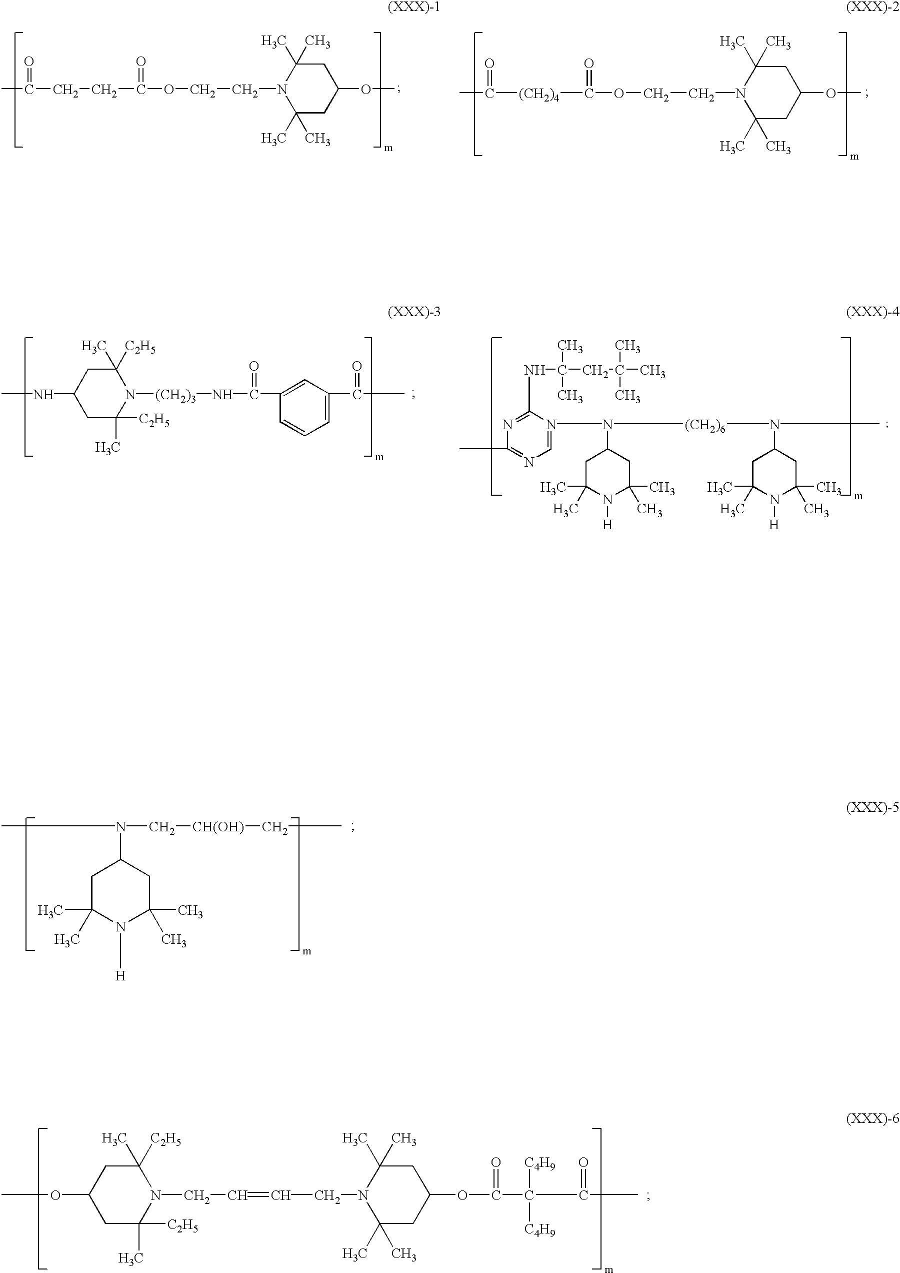

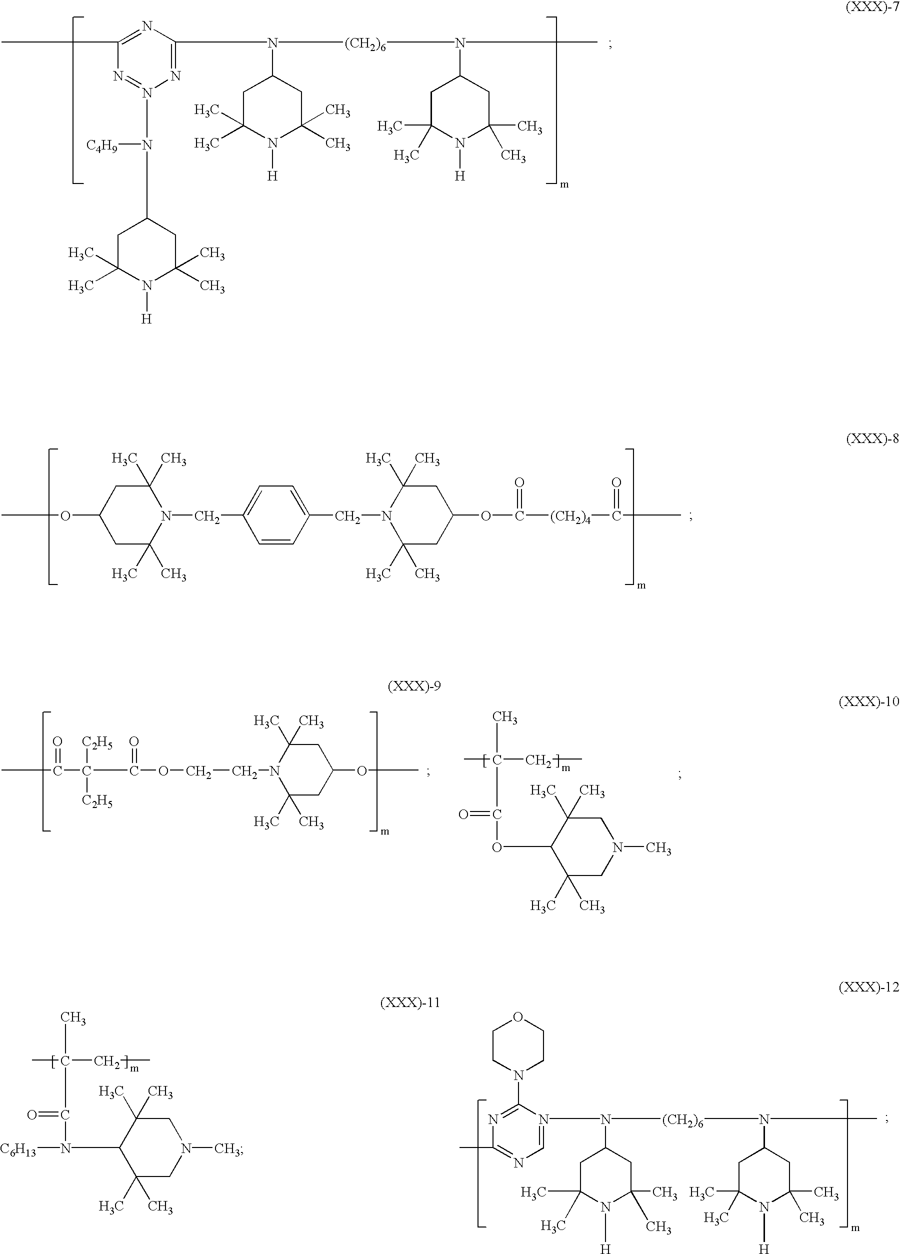

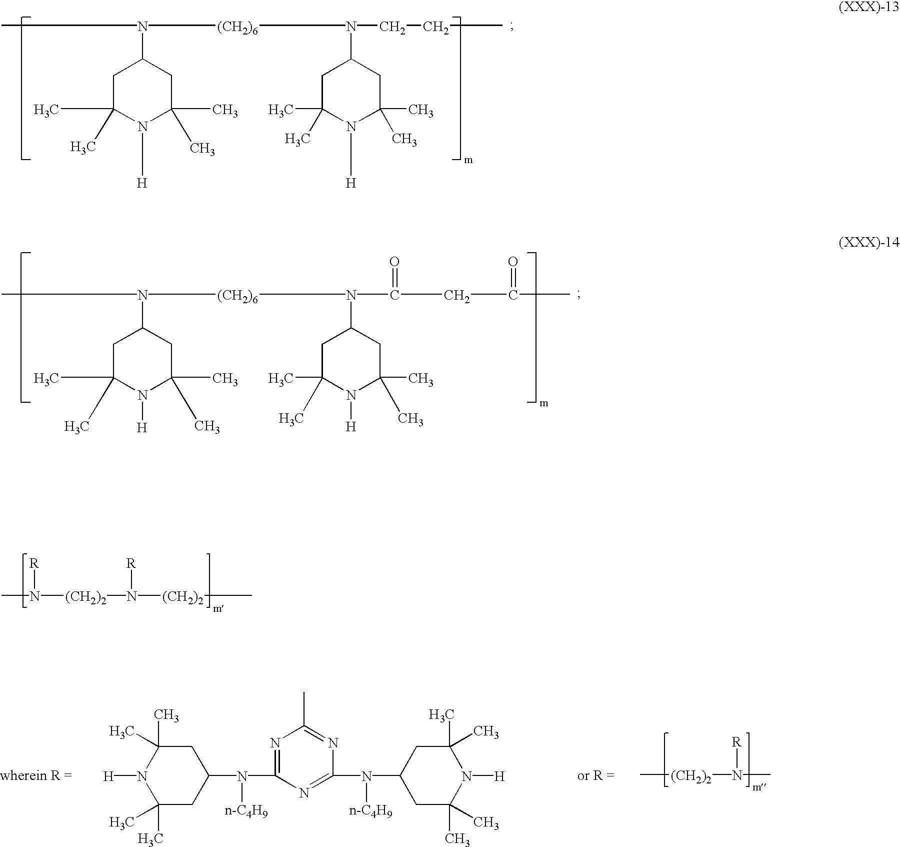

wherein m′ and m″ are an integer ranging from 0 to 200, extremes included, on the condition that m′+m″ is m.

Further examples of polymeric compounds (f′) useful for the purposes of the present invention are:

the reaction products between compounds having formula (XXXI):

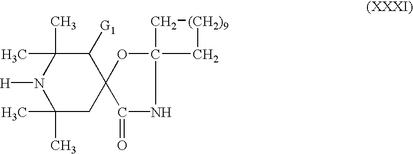

and epichlorohydrin;

polyesters obtained from the reaction of butane-1,2,3,4-tetracarboxylic acid with a bifunctional alcohol having formula (XXXII):

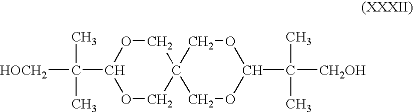

whose carboxylic termination deriving from tetracarboxylic acid has been esterified with a 2,2,6,6-tetramethyl-4-hydroxypiperidine group;

compounds having general formula (XXXIII):

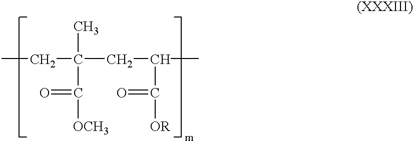

wherein about a third of the R radicals represent a —C₂H₅ group and the remainder a group having the formula:

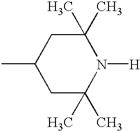

and m is a number ranging from 2 to 200, extremes included;

copolymers whose recurrent unit consists of two units having the formula:

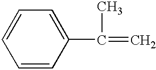

and, in each case, of a unit having the formula:

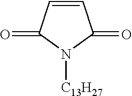

and a unit having the formula:

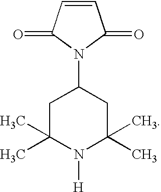

(g′) Compounds having general formula (XXXIV):

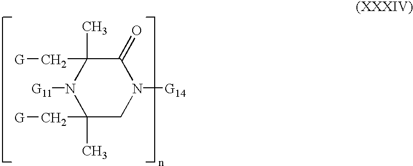

wherein n is 1 or 2, G and G₁₁ have the same meanings defined above under point (a′) and G₁₄ has the same meanings described above under point (b′), on the condition that G₁₄ can never represent the group —CONH—Z or the group —CH₂—CH(OH)—CH₂—O—D—O.

Examples of compounds having general formula (XXXIV) are the following:

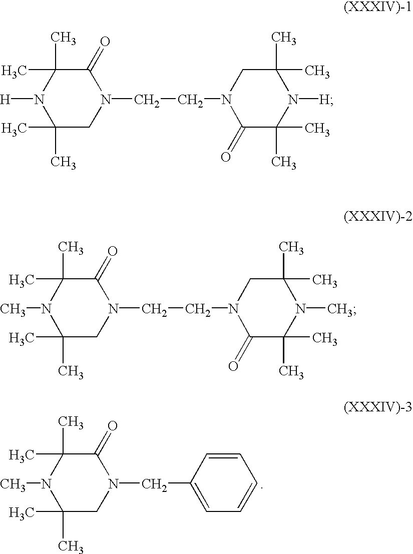

(h′) Compounds having general formula (XXXV):

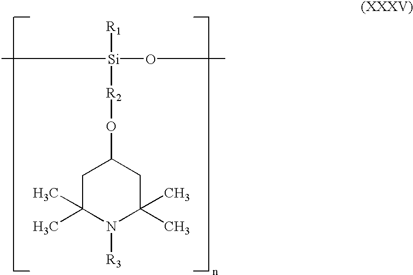

wherein R₁ represents a C₁-C₁₀ alkyl group, a C₅-C₁₂ cycloalkyl group optionally substituted with a C₁-C₄ alkyl group, a phenyl optionally substituted with a C₁-C₁₀ alkyl group; R₂ represents a C₃-C₁₀ alkylene group; R₃ represents a hydrogen atom, a C₁-C₈ alkyl group, O, a —CH₂CN group, a C₃-C₆ alkenyl group, a C₇-C₉ phenylalkyl group optionally substituted in the phenyl radical with a C₁-C₄ alkyl group, a C₁-C₈ acyl group, an —OR′₃ group wherein R′₃ represents a C₁-C₁₀ alkyl group; and n is a number ranging from 1 to 50, extremes included.

Of particular interest for the purposes of the present invention are compounds belonging to the group of sterically hindered amines (d), selected from: Tinuvin® 123 of Ciba Specialty Chemicals; Tinuvin® 144 of Ciba Specialty Chemicals; Lowilite® 76 of Great Lakes Chemical Corporation; Lowilite® 62 of Great Lakes Chemical Corporation; Lowilite® 94 of Great Lakes Chemical Corporation; Chimassorb® 119 of Ciba Specialty Chemicals; the compound having formula (XXXV)-1:

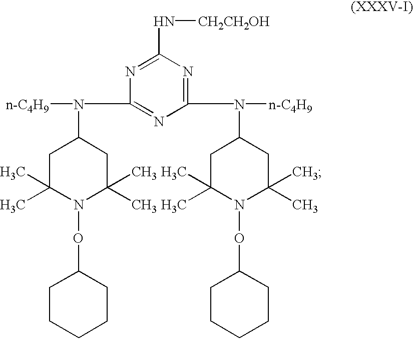

poly-methylpropyl-3-oxy-[4-(2,2,6,6tetramethyl)piperidinyl]siloxane, known under the trade-name of UVASIL® 299 of Great Lakes Chemical Corporation; polymethylpropyl-3-oxy-[4-(1,2,2,6,6-pentamethyl)piperidinyl]siloxane.

Compounds belonging to the group of sterically hindered amines (d) useful for the purposes of the present invention are those having an average molecular weight Mₙ ranging from 500 to 10,000, in particular from 1,000 to 10,000.

The stabilizing mixtures, object of the present in- vention, are capable of stabilizing organic polymers against degradation caused by oxygen, heat and/or light. Examples of organic polymers to which they can be added are:

1. Polymers of mono-olefins and di-olefins such as, for example, polypropylene, polyisobutylene, polybut-1-ene, poly-4-methylpent-1-ene, polyisoprene or polybutadiene; as well as polymers of cyclo-olefins such as, for example, cyclopentene or norbornene; polyethylene (which can be optionally cross-linked) such as, for example, high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), branched low density polyethylene (BLDPE), (VLDPE), (ULDPE).

Polyolefins such as, for example the mono-olefins mentioned in the above paragraph, preferably polyethylene and polypropylene, can be prepared with many methods known in literature, preferably using the following methods:

(a) radicalic polymerization (generally carried out at a high pressure and high temperature);

(b) catalytic polymerization using a catalyst which normally contains one or more metals of groups IVb, Vb, VIb or VIII of the Periodic Table. These metals generally have one or more ligands such as, for example, oxides, halides, alcoholates, esters, ethers, amines, alkyls, alkenyls and/or aryls which can be π- or σ-coordinated. These metal complexes can be in free form or supported on substrates such as, for example, activated magnesium chloride, titanium(III) chloride, alumina or silicon oxide. Said catalysts can be soluble or insoluble in the polymerization medium. The catalysts can be used alone or in the presence of other activators such as, for example, metal alkyls, metal hydrides, halides of metal alkyls, oxides of metal alkyls or metal alkyloxanes, these metals being elements belonging to groups Ia, IIa and/or IIIa of the Periodic Table. The activators can be conveniently modified with other ester, ether, amine or silyl-ether groups. These catalytic systems are usually called Phillips, Standard Oil Indiana, Ziegler(-Natta), TNZ (Du-Pont), metallocene or “single site catalyst” (SSC).

2. Mixtures of the polymers described under point (1) such as, for example, mixtures of polypropylene with polyisobutylene; mixtures of polypropylene with polyethylene (for example, PP/HDPE, PP/LDPE); mixtures of different types of polyethylene (for example, LDPE/HDPE).

3. Copolymers of mono-olefins and di-olefins with each other or with other vinyl monomers such as, for example, ethylene/propylene copolymers, linear low density polyethylene (LLDPE) and its mixtures with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or ethylene/acrylic acid copolymers and their salts (ionomers) as well as terpolymers of ethylene with propylene and a diene such as, for example, hexadiene, dicyclopentadiene or ethylidene-norbornene; and also mixtures of said copolymers with each other or with the polymers cited in under point (1) such as, for example, polypropylene/ethylene/propylene copolymers, LDPE/ethylene/vinyl-acetate (EVA) copolymers, LDPE/ethylene/acrylic acid (EAA) copolymers, LLDPE/EVA, LLDPE/EAA, and alternating or random polyalkylene/carbon monoxide copolymers and their mixtures with other polymers such as, for example, polyamides.

4. Hydrocarbon resins (for example, C₅-C₉) comprising their hydrogenated modifications (for example, adhesive resins) and mixtures with polyalkylene and starch.

5. Polystyrene, poly(p-methylstyrene), poly(α-methylstyrene).

6. Copolymers of styrene or α-methylstyrene with dienes or acrylic derivatives such as, for example, styrene/butadiene, styrene/acrylonitrile, styrene/alkyl methacrylate, styrene/butadiene/alkyl acrylate, styrene/ butadiene/alkyl methacrylate, styrene/maleic anhydride, styrene/acrylonitrile/methyl acrylate; mixtures, having a high impact strength, between copolymers of styrene and another polymer such as, for example, a polyacrylate, a polymer of a diene or an ethylene/propylene/diene terpolymer, block copolymers of styrene such as, for example, styrene/butadiene/styrene, styrene/isoprene/styrene, styrene/ethylene/butylene/styrene or styrene/ethylene/propylene/styrene.

7. Grafted copolymers of styrene or of α-methylstyrene such as, for example, styrene in polybutadiene, styrene in polybutadiene/styrene or polybutadiene/acrylonitrile copolymers; styrene and acrylonitrile (or methacrylonitrile) in polybutadiene; styrene, acrylonitrile and methylmethacrylate in polybutadiene; styrene and maleic anhydride in polybutadiene; styrene, acrylonitrile and maleic anhydride or maleimide in polybutadiene; styrene and maleimide in polybutadiene; styrene and alkylacrylates or alkylmethacrylates in polybutadiene; styrene and acrylonitrile in ethylene/propylene/diene terpolymers, styrene and acrylonitrile in polyalkyl acrylates or polyalkyl methacrylates, styrene and acrylonitrile in acrylate/butadiene copolymers, as well as mixtures of the copolymers listed above with the copolymers cited under point (6) such as, for example, mixtures of known copolymers such as ABS, MBS, ASA or AES.

8. Polymers containing halogens such as, for example, polychloroprene, chlorinated rubbers, chlorinated or brominated isobutylene-isoprene copolymers (“halobutyl rubber”), chlorinated or chlorosulfonated polyethylene, ethylene and chlorinated ethylene copolymers, homopolymers and copolymers of epichlorohydrin, in particular polymers of vinyl compounds containing halogens such as, for example, polyvinyl chloride, polyvinylidene chloride, polyvinyl fluoride or polyvinylidene fluoride; and also their copolymers such as, for example, vinyl chloride/vinylidene chloride, vinyl chloride/vinyl acetate or vinylidene chloride/vinyl acetate.

9. Polymers deriving from α,β-unsaturated acids and their derivatives such as, for example, polyacrylates and polymethacrylates, polymethyl methacrylates, polyacrylamides and polyacrylonitriles, impact modified with butyl acrylate.

10. Copolymers of monomers according to point (9) with each other or with other unsaturated monomers such as, for example, acrylonitrile/butadiene copolymers, acrylonitrile/alkyl acrylate copolymers, acrylonitrile/alkoxyalkyl acrylate copolymers or acrylonitrile/vinyl halide copolymers or acrylonitrile/alkyl methacrylate/butadiene terpolymers.

11. Polymers deriving from unsaturated alcohols and amines, or their acyl or acetal derivatives such as, for example, polyvinyl alcohol, polyvinyl acetate, polyvinyl stearate, polyvinyl benzoate, polyvinyl maleate, polyvinyl butyral, polyallyl phthalate or polyallyl melamine; and also their copolymers with the olefins listed under point (1).

12. Homopolymers and copolymers of open-chain ethers or cyclic ethers such as, for example, polyalkylene glycols, polyethylene oxide, polypropylene oxide, or copolymers of the compounds described above with bis-glycidyl ethers.

13. Polyacetals such as, for example, polyoxymethylene and those polyoxymethylenes containing comonomers, for example, ethylene oxide; polyacetals modified with thermoplastic polyurethanes, acrylates or MBS.

14. Polyphenylene oxides and sulfides and their mixtures with styrene polymers or polyamides.

15. Polyurethanes deriving from hydroxyl-terminated polyethers, polyesters or polybutadienes on the one hand and aliphatic or aromatic polyisocyanates on the other, as well as their precursors.

16. Polyamides and copolyamides deriving from diamines and dicarboxylic acids and/or aminocarboxylic acids or from the corresponding lactams such as, for example, polyamide 4, polyamide 6, polyamide 6/6, 6/10, 6/9, 6/12, 4/6, 12/12, polyamide 11, polyamide 12, aromatic polyamides obtained starting from m-xylene diamine and adipic acid; polyamides prepared from hexamethylenediamine and isophthalic and/or terephthalic acid and with or without an elastomer as modifier, for example, poly-2,4,4-trimethylhexamethylene terephthalamide or poly-m-phenylene isophthalamide; and also block copolymers of the above polyamides with polyolefins, olefinic copolymers, ionomers or elastomers chemically bound or grafted; or with polyethers such as, for example, polyethylene glycol, polypropylene glycol or polytetramethylene glycol; as well as polyamides or copolyamides modified with EPDM or ABS; and polyamides condensed during processing (“RIM polyamide system”).

17. Polyureas, polyimides, polyamide-imides, polyetherimides, polyesterimides, polyhydantoins, and polybenzoimidazoles.

18. Polyesters deriving from dicarboxylic acids and diols and/or from hydroxycarboxylic acids or from the corresponding lactones such as, for example, polyethylene terephthalate, polybutylene terephthalate, poly-1,4-dimethylolcyclohexane terephthalate and polyhydroxybenzoates, as well as block copolyether esters deriving from polyethers with hydroxyl-terminated groups; and also polyesters modified with polycarbonates or MBS.

19. Polycarbonates and polyester carbonates.

20. Polysulfones, polyethersulfones and polyetherketones.

21. Cross-linked polymers deriving from aldehydes on the one hand and from phenols, urea and melamines on the other, such as, for example, phenol/formaldehyde, resins, urea/formaldehyde resins and melamine/formaldehyde resins.

22. Dried or non-dried alkyd resins.

23. Resins based on unsaturated polyesters deriving from copolyesters of dicarboxylic acids saturated and unsaturated with polyhydric alcohols and vinyl compounds as cross-linking agents, and also the above resins containing halogens and having a good flame-resistance.

24. Cross-linkable acrylic resins deriving from substituted acrylates such as, for example, epoxy acrylates, urethane acrylates or polyester acrylates.

25. Alkyd resins, resins based on polyesters or acrylated resins cross-linked with melamine resins, resins based on urea, resins based on isocyanates, resins based on isocyanurates, resins based on polyisocyanates or epoxy resins.

26. Cross-linked epoxy resins deriving from aliphatic, cycloaliphatic, heterocyclic or aromatic glycidyl compounds such as, for example, products of diglycidyl ethers of bisphenol A and bisphenol F, which are cross-linked with the usual cross-linking agents such as, for example, anhydrides or amines, in the presence of or without accelerating agents.

27. Natural polymers such as, for example, cellulose, natural rubber, gelatin; and their derivatives chemically modified to give homologous polymers such as, for example, cellulose acetates, propionates and butyrates, or cellulose ethers such as methyl-cellulose; as well as hydrocarbon resins (“rosins”) and their derivatives.

28. Mixtures of the above polymers (“polyblends”) such as, for example, PP/EPDM, polyamides/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylates, POM/MBS, PPO/HIPS, PPO/PA 6.6 and copolymers, PA/HDPE, PA/PP, PA/PPO, PBT/PC/ABS, PBT/PET/PC.

29. Natural or synthetic organic materials which are pure monomeric compounds or mixtures of said compounds, such as, for example, mineral oils, animal or vegetable oils, fats or waxes, oils, fats or waxes based on synthetic esters (for example, phthalates, adipates, phosphates, trimellitates), as well as mixtures of synthetic esters with mineral oils in any weight ratio, in particular those used in spinning compositions, as well as aqueous emulsions of said organic materials.

30. Aqueous emulsions of natural or synthetic rubbers such as, for example, natural latex or latexes based on carboxylated styrene-butadiene copolymers.

The organic polymers which can be stabilized with the mixtures, object of the present invention, are, preferably, natural, semi-synthetic or synthetic polymers selected from those described above. More preferably, the mixtures, object of the present invention, are useful in the stabilization of thermoplastic polymers, especially polyolefins, in particular polyethylene and polypropylene or their copolymers with mono- and di-olefins.

A further object of the present invention therefore relates to polymeric compositions containing an organic polymer and an effective quantity of one of the stabilizing mixtures, object of the present invention. Yet another object of the present invention relates to the end-products obtained from the processing of the above polymeric compositions.

The stabilizing mixtures, object of the present invention, are particularly useful against degradation caused by oxygen and heat and are consequently exceptionally useful as process stabilizers.

Compounds (a), (b) and (c) and, optionally, (d) of the above stabilizing mixtures can be added to the organic polymers to be stabilized either individually or mixed with each other.

Compound (a) is added to the organic polymers to be stabilized in a quantity ranging from 0.001% to 2.5% with respect to the weight of the organic polymer to be stabilized, preferably from 0.005% to 2%, for example, from 0.01% to 1%.

Compounds (b), (c) and, optionally, (d), are added to the organic polymers to be stabilized in a quantity ranging from 0.01% to 10% with respect to the weight of the organic polymer to be stabilized, for example from 0.01% to 5%, preferably from 0.025% to 3%, even more preferably from 0.025% to 1%.

The stabilizing mixtures object of the present invention can optionally contain other stabilizers (co-stabilizers).

Stabilizers for organic polymers useful for the purpose are selected from the following groups:

1. Antioxidants

1.1 Alkylated monophenols such as, for example: 2,6-di-t-butyl-4-methylphenol; 2-t-butyl-4,6-dimethylphenol; 2,6-di-t-butyl-4-ethylphenol; 2,6-di-t-butyl-4-n-butylphenol; 2,6-di-t-butyl-4-isobutylphenol; 2,6-dicyclopentyl-4-methylphenol; 2-(α-methylcyclohexyl)-4,6-dimethylphenol; 2,6-dioctadecyl-4-methylphenol; 2,4,6-tricyclohexylphenol; 2,6-di-t-butyl-4-methoxymethylphenol; nonylphenols with a linear or branched alkyl chain such as, for example, 2,6-dinonyl-4-methylphenol; 2,4-dimethyl-6-(1′-methylundec-1′-yl)phenol; 2,4-dimethyl-6-(1′-methylheptadec-1′-yl)phenol; 2,4-dimethyl-6-(1′-methyltridec-1′-yl)phenol; and their mixtures.

1.2 Alkylthiomethylphenols such as, for example: 2,4-dioctylthiomethyl-6-t-butylphenol; 2,4-dioctylthiomethyl-6-methylphenol; 2,4-dioctylthiomethyl-6-ethylphenol; 2,6-didodecylthiomethyl-4-nonylphenol.

1.3 Hydroquinones and alkylated hydroquinones such as, for example: 2,6-di-t-butyl-4-methoxyphenol; 2,5-di-t-butylhydroquinone; 2,5-di-t-amylhydroquinone; 2,6-di-phenyl-4-octadecyloxyphenol; 2,6-di-t-butylhydroquinone; 2,5-di-t-butyl-4-hydroxyanisol; 3,5-di-t-butyl-4-hydroxyanisol; 3,5-di-t-butyl-4-hydroxyphenyl stearate; bis(3,5-di-t-butyl-4-hydroxyphenyl)adipate.

1.4 Tocopherols such as, for example: α-tocopherol, β-tocopherol, γ-tocopherol, δ-tocopherol and their mixtures (Vitamin E).

1.5 Hydroxylated thiodiphenyl ethers such as, for example 2,2′-thiobis-(6-t-butyl-4-methylphenol); 2,2′-thiobis-(4-octylphenol); 4,4′-thiobis-(6-t-butyl-3-methylphenol); 4,4′-thiobis-(6-t-butyl-2-methylphenol); 4,4′-thiobis-(3,6-di-s-amylphenol); 4,4′-bis-(2,6-dimethyl-4-hydroxyphenyl)disulfide.

1.6 Alkylidene-bisphenols such as, for example: 2,2′-methylenebis-(6-t-butyl-4-methylphenol); 2,2′-methylenebis-(6-t-butyl-4-ethylphenol); 2,2′-methylenebis[4-methyl-6-(α-methylcyclohexyl)phenol]; 2,2′-methylene-bis(4-methyl-6-cyclohexylphenol); 2,2′-methylenebis(6-nonyl-4-methylphenol); 2,2′-methylenebis(4,6-di-t-butylphenol); 2,2′-ethylidenebis(4,6-di-t-butylphenol); 2,2′-ethylidenebis(6-t-butyl-4-isobutylphenol);2,2′-methylenebis[6-(α-methylbenzyl)-4-nonylphenol]; 2,2′-methylenebis[6-(α,α-dimethylbenzyl)-4-nonylphenol]; 4,4′-methylenebis (2,6-di-t-butylphenol); 4,4′-methylenebis(6-t-butyl-2-methylphenol); 1,1-bis(5-t-butyl-4-hydroxy-2-methylphenyl)butane; 2,6-bis(3-t-butyl-5-methyl-2-hydroxybenzyl)-4-methylphenol; 1,1,3-tris-(5-t-butyl-4-hydroxy-2-methylphenyl) butane; 1,1-bis(5-t-butyl-4-hydroxy-2-methylphenyl)-3-n-dodecylmercaptobutane; ethyleneglycol bis[3,3-bis-(3′-t-butyl-4′-hydroxyphenyl)butyrate]; bis-(3-t-butyl-4-hydroxy-5-methylphenyl) dicyclopentadiene; bis[2-(3′-t-butyl-2′-hydroxy-5′-methylbenzyl)-6-t-butyl-4-methylphenyl]terephthalate; 1,1-bis(3,5-dimethyl-2-hydroxyphenyl)butane; 2,2-bis(3,5-di-t-butyl-4-hydroxy-phenyl) propane; 2,2-bis(5-t-butyl-4-hydroxy-2-methylphenyl)-4-n-dodecylmercaptobutane; 1,1,5,5-tetra(5-t-butyl-4-hydroxy-2-methylphenyl)pentane.

1.7 Benzyl compounds containing O, N or S such as, for example: 3,5,3′,5′-tetra-t-butyl-4,4′-dihydroxydibenzyl-ether; octadecyl-4-hydroxy-3,5-dimethylbenzylmercaptoacetate; tridecyl-4-hydroxy-3,5-di-t-butyl-benzylmercaptoacetate; tris(3,5-di-t-butyl-4-hydroxybenzyl)amine; bis (4-t-butyl-3-hydroxy-2,6-dimethylbenzyl)dithioterephthalate; bis(3,5-di-t-butyl-4-hydroxybenzyl)sulfide; isooctyl-3,5-di-t-butyl-4-hydroxybenzylmercaptoacetate.

1.8 Hydroxybenzylated malonates such as, for example: dioctadecyl-2,2-bis(3,5-di-t-butyl-2-hydroxybenzyl)malonate; dioctadecyl-2-(3-t-butyl-4-hydroxy-5-methylbenzyl)malonate; didodecylmercaptoethyl-2,2-bis(3,5-di-t-butyl-4-hydroxybenzyl)malonate; bis[4-(1,1,3,3-tetramethylbutyl)phenyl]-2,2-bis(3,5-di-t-butyl-4-hydroxybenzyl)malonate.

1.9 Aromatic hydroxybenzyl compounds such as, for example: 1,3,5-tris(3,5-di-t-butyl-4-hydroxybenzyl)-2,4,6-trimethylbenzene; 1,4-bis-(3,5-di-t-butylhydroxybenzyl)-2,3,5,6-tetramethylbenzene; 2,4,6-tris(3,5-di-t-butyl-4-hydroxybenzyl)phenol.

1.10 Triazine compounds such as, for example: 2,4-bis(octylmercapto)-6-(3,5-di-t-butyl-4-hydroxyaniline)-1,3,5-triazine; 2-octylmercapto-4,6-bis(3,5-di-t-butyl-4-hydroxyaniline)-1,3,5-triazine; 2-octylmercapto-4,6-bis-(3,5-di-t-butyl-4-hydroxyphenoxy)-1,3,5-triazine; 2,4,6-tris-(3,5-di-t-butyl-4-hydroxyphenoxy)-1,2,3-triazine; 1,3,5-tris(3,5-di-t-butyl-4-hydroxybenzyl)isocyanurate; 1,3,5-tris(4-t-butyl-3-hydroxy-2,6-dimethylbenzyl)isocyanurate; 2,4,6-tris-(3,5-di-t-butyl-4-hydroxyphenylethyl)-1,3,5-triazine; 1,3,5-tris(3,5-di-t-butyl-4-hydroxyphenylpropionyl)hexahydro-1,3,5-triazine; 1,3,5-tris(3,5-dicyclohexyl-4-hydroxybenzyl)isocyanurate.

1.11 Benzylphosphonates such as, for example: dimethyl-2,5-di-t-butyl-4-hydroxybenzylphosphonate; diethyl-3,5-di-t-butyl-4-hydroxybenzylphosphonate; dioctadecyl-3,5-di-t-butyl-4-hydroxybenzylphosphonate; dioctadecyl-5-t-butyl-4-hydroxy-3-methylbenzylphosphonate; calcium salts of monoethyl ester of 3,5-di-t-butyl-4-hydroxybenzylphosphonic acid.

1.12 Acylaminophenols such as, for example: 4-hydroxylauranilide, 4-hydroxystearanilide; octyl-N-(3,5-di-t-butyl-4-hydroxyphenyl)carbamate.

1.13 Esters of β-(3,5-di-t-butyl-4-hydroxyphenyl)propionic acid with monohydric or polyhydric alcohols such as, for example: methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thioundecanol, 3-thiopentadecanol, trimethylhexanediol, trimethylolpropane, 4-hydroxymethyl-1-phospho-2,6,7-trioxabicyclo-[2.2.2]-octane.

1.14 Esters of β-(5-t-butyl-4-hydroxy-3-methylphenyl)propionic acid with monohydric or polyhydric alcohols such as, for example: methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thioundecanol, 3-thiopentadecanol, trimethylhexanediol, trimethylolpropane, 4-hydroxymethyl-1-phospho-2,6,7-trioxabicyclo[2.2.2]octane.

1.15 Esters of β-(3,5-dicyclohexyl-4-hydroxyphenyl)propionic acid with monohydric or polyhydric alcohols such as, for example: methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thioundecanol, 3-thiopentadecanol, trimethylhexanediol, trimethylolpropane, 4-hydroxymethyl-1-phospho-2,6,7-trioxabicyclo[2.2.2]-octane.

1.16 Esters of (3,5-di-t-butyl-4-hydroxyphenyl) acetic acid with monohydric or polyhydric alcohols such as, for example: methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thioundecanol, 3-thiopentadecanol, trimethylhexanediol, trimethylolpropane, 4-hydroxymethyl-1-phospho-2,6,7-trioxabicyclo[2.2.2]octane.

1.17 Amides of β-(3,5-di-t-butyl-4-hydroxyphenyl)propionic acid such as, for example: N,N′-bis(3,5-di-t-butyl-4-hydroxyphenylpropionyl)hexamethylenediamide; N,N′-bis(3,5-di-t-butyl-4-hydroxyphenylpropionyl)trimethylenediamide; N,N′-bis(3,5-di-t-butyl-4-hydroxyphenylpropionyl) hydrazide; N,N′-bis[2-(3-[3,5-di-t-butyl-4-hydroxyphenyl]propionyloxy)ethyl]oxamide (Naugard® XL-1 of Uniroyal).

1.18 Ascorbic acid (vitamin C).

1.19 Aminic antioxidants such as, for example, N,N′-di-isopropyl-p-phenylenediamine; N,N′-di-s-butyl-p-phenylenediamine; N,N′-bis(1,4-dimethylpentyl)-p-phenylenediamine; N,N′-bis(1-ethyl-3-methylpentyl)-p-phenylenediamine; N,N′-bis(1-methylheptyl)-p-phenylenediamine; N,N′-dicyclohexyl-p-phenylenediamine; N,N′-diphenyl-p-phenylenediamine; N,N′-bis(2-naphthyl)-p-phenylenediamine; N-isopropyl-N′-phenyl-p-phenylenediamine; N-(1,3-dimethyl- butyl)-N′-phenyl-p-phenylenediamine; N-(1-methylheptyl)-N′-phenyl-p-phenylenediamine; N-cyclohexyl-N′-phenyl-p-phenylenediamine; 4-(p-toluenesulfonamide)diphenyleneamine; N,N′-dimethyl-N,N′-di-s-butyl-p-phenylenediamine; diphenylamine; N-allyldiphenylamine; 4-isopropoxy-diphenylamine; N-phenyl-1-naphthylamine; N-(4-t-octylphenyl)1-naphthylamine; N-phenyl-2-naphthylamine; diphenylamine octylate such as, for example, p,p′-di-t-octyldiphenylamine; 4-n-butylaminophenol; 4-butirylaminophenol; 4-nonanoylaminophenol; 4-dodecanoylaminophenol; 4-octadecanoylaminophenol; bis(4-methoxyphenyl)amine; 2,6-di-t-butyl-4-dimethylaminomethylphenol; 2,4′-diaminodiphenylmethane; 4,4′-diaminodiphenylmethane; N,N,N′,N′-tetramethyl-4,4′-diaminodiphenylmethane; 1,2-bis[(2-methylphenyl)amino]ethane; 1,2-bis(phenylamino)propane; (o-tolyl)biguanide; bis[4-(1′,3′-dimethylbutyl)phenyl]amine; N-phenyl-1-naphthylamine t-octylate; mixture of mono- and dialkylated t-butyl/t-octyldiphenylamines; mixture of mono- and dialkylated nonyldiphenylamines; mixture of mono- and dialkylated dodecyldiphenylamines; mixture of mono- and dialkylated isopropyl/isohexyldiphenylamines; mixture of mono- and dialkylated t-butyldiphenylamines; 2,3-dihydro-3,3-dimethyl-4H-1,4-benzothiazine; phenothiazine; mixture of mono- and dialkylated t-butyl/t-octylphenothiazines; mixture of mono- and dialkylated t-octyl-phenothiazines; N-allyl-phenothiazine; N,N,N′,N′-tetraphenyl-1,4-diamino-but-2-ene; N,N-bis(2,2,6,6-tetramethylpiperid-4-yl)hexamethylenediamine; bis-(2,,2,6,6-tetramethylpiperidin-4-yl) sebacate; 2,2,6,6-tetramethylpiperidin-4-one; 2,2,6,6-tetramethylpiperidin-4-ol.

2. UV ray and light stabilizers.

2.1 Derivatives of 2-(2′-hydroxyphenyl)benzotriazoles such as, for example: 2-(2′-hydroxy-5′methylphenyl)benzotriazole; 2-(3′,5′-di-t-butyl-2′-hydroxyphenyl)benzotriazole; 2-(5′-t-butyl-2′-hydroxyphenyl)benzotriazole; 2-[2′-hydroxy-5′-(1,1,3,3-tetramethylbutyl)phenyl]benzotriazole; 2-(3′,5′-di-t-butyl-2′-hydroxyphenyl)-5-chlorobenzotriazole; 2-(3′-t-butyl-2′-hydroxy-5′-methylphenyl)-5-chlorobenzotriazole; 2-(3′-s-butyl-5′-t-butyl-2′-hydroxyphenyl)benzotriazole; 2-(2′-hydroxy-4′-octyloxyphenyl)benzotriazole; 2-(3′,5′-di-t-amyl-2′-hydroxyphenyl)benzotriazole; 2-[3′,5′-bis(α,α-dimethylbenzyl)-2′-hydroxyphenyl]benzotriazole; 2-[3′-t-butyl-2′-hydroxy-5′-(2-octyloxycarbonylethyl)phenyl]-5-chlorobenzotriazole, 2-[3′-t-butyl-5′-(2-(2-ethylhexyloxy)carbonylethyl)-2′-hydroxyphenyl]-5-chlorobenzotriazole, 2-[3′-t-butyl-2′-hydroxy-5′-(2-methoxycarbonylethyl)phenyl]-5-chlorobenzotriazole, 2-[3′-t-butyl-2′-hydroxy-5′-(2-methoxycarbonylethyl)phenyl]benzotriazole, 2-[3′-t-butyl-2′-hydroxy-5′-(2-octyloxycarbonylethyl)phenyl]benzotriazole, 2-[3′-t-butyl-5′-(2-(2-ethylhexyloxy)carbonylethyl)-2′-hydroxyphenyl]benzotriazole, 2-(3′-dodecyl-2′-hydroxy-5′-methylphenyl)benzotriazole; 2-[3′-t-butyl-2′-hydroxy-5′-(2-isooctyloxycarbonylethyl)phenyl]benzotriazole, 2,2′-methylene-bis[4-(1,1,3,3-tetramethylbutyl)-6-benzotriazol-2-yl-phenol]; transesterification product of 2-[3′-t-butyl-5′-(2-methoxycarbonylethyl)-2′-hydroxyphenyl]-2H-benzotriazole with polyethylene glycol 300; [R—CH₂CH₂—COO—CH₂CH₂—]₂— wherein R=3′-t-butyl-4′-hydroxy-5′-2H-benzotriazol-2-yl-phenyl; 2-[2′-hydroxy-3′-(α,α-dimethylbenzyl)-5′-(1,1,3,3-tetramethylbutyl)phenyl]benzotriazole; 2-[2′-hydroxy-3′-(1,1,3,3-tetramethylbutyl)-5′-(α,α-dimethylbenzyl)phenyl]benzotriazole.

2.2 Benzotriazoles deriving from hydantoin such as those described, for example in patent applications EP 867,435, WO 99/23093.and WO 99/37638.

2.3 Derivatives of 2-hydroxybenzophenones such as, for example: 4-hydroxy-; 4-methoxy-; 4-octyloxy-; 4-decyloxy-; 4-dodecyloxy-; 4-benzyloxy-; 4,2′,4′-trihydroxy-; 2′-hydroxy-4,4′-dimethoxy.

2.4 Esters of benzoic acids, optionally substituted, such as, for example: phenyl salicylate, 4-t-butylphenyl salicylate, octylphenyl salicylate, benzoyl resorcinol, bis(4-t-butylbenzoyl) resorcinol, dibenzoyl resorcinol, 2,4-di-t-butylphenyl-3,5-di-t-butyl-4-hydroxybenzoate, hexadecyl-3,5-di-t-butyl-4-hydroxybenzoate, octadecyl-3,5-di-t-butyl-4-hydroxybenzoate, 2-methyl-4,6-di-t-butylphenyl-3,5-di-t-butyl-4-hydroxybenzoate.

2.5 Acrylates such as, for example, ethyl or iso-octyl α-cyano-β,β-diphenylacrylate; methyl α-carbomethoxycinnamate, methyl or butyl α-cyano-β-methyl-p-methoxycinnamate, methyl α-carbomethoxy-p-methoxycinnamate, N-(β-carbomethoxy-β-cyanovinyl)-2-methylindoline.

2.6 Nickel compounds such as, for example, Ni-complexes of 2,2′-thio-bis-[4-(1,1,3,3-tetramethylbutyl)phenol], for example 1:1 or 1:2 complexes, with or without additional ligands such as n-butylamine, triethanolamine or N-cyclohexyldiethanolamine, nickel dibutyldithiocarbamate, nickel salts of monoalkyl esters of 4-hydroxy-3,5-di-t-butyl-benzylphosphonic acid, such as methyl or ethyl esters, nickel complexes with ketoximes such as 2-hydroxy-4-methylphenyl undecyl ketoxime, nickel complexes of 1-phenyl-4-lauroyl-5-hydroxypyrazol with or without additional ligands.

2.7 Sterically hindered amines and their N-alkoxy derivatives such as, for example: poly-methylpropyl-3-oxy-[4-(2,2,6,6-tetramethyl)piperidinyl]siloxane, polymethylpropyl-3-oxy-[4-(1,2,2,6,6-pentamethyl)piperidinyl]siloxane, bis-(2,2,6,6-tetramethyl-4-piperidinyl)sebacate; bis(2,2,6,6-tetramethyl-4-piperidinyl)succinate; bis (1,2,2,6,6-pentamethyl-4-piperidinyl)sebacate; bis(1-octyloxy-2,2,6,6-tetramethyl-4-piperidinyl)sebacate; bis(1,2,2,6,6-pentamethyl-4-piperidyl)-n-butyl-3,5-di-t-butyl-4-hydroxybenzylmalonate; condensation product between 1-(2-hydroxyethyl)-2,2,6,6-tetramethyl-4-hydroxy-piperidine and succinic acid; condensation product, linear or cyclic, between N,N′-bis(2,2,6,6-tetramethyl-4-piperid-yl)hexamethylendiamine and 4-t-octylamino-2,6-dichloro-1,3,5-s-triazine; tris(2,2,6,6-tetramethyl-4-piperidyl) nitrilo-triacetate; tetrakis(2,2,6,6-tetramethyl-4-piperidyl)-1,2,3,4-butanetetracarboxylate; 1,1′-(1,2-ethanodiyl) bis (3,3,5,5-tetramethylpiperazinone; 4-benzoyl-2,2,6,6-tetramethylpiperidine; 4-stearyloxy-2,2,6,6-tetramethylpiperidine; bis(1,2,2,6,6-penta-methylpiperidyl)-2-n-butyl-2-(2-hydroxy-3,5-di-t-butylbenzyl)malonate; 3-n-octyl-7,7,9,9-tetramethyl-1,3,8-triazaspiro[4.5]decane-2,4-dione; bis(1-octyloxy-2,2,6,6-tetramethylpiperidyl) sebacate; bis(1-octyloxy-2,2,6,6-tetramethylpiperidyl) succinate; condensation product, linear or cyclic,between N,N′-bis(2,2,6,6-tetramethyl-4-piperidyl)hexamethylenediamine and 4-morpholine-2,6-di-chloro-1,3,5-triazine; condensation product between 2-chloro-4,6-di-(4-n-butylamino-2,2,6,6-tetramethyl-piperidyl)-1,3,5-triazine and 1,2-bis(3-aminopropylamino) ethane; condensation product between 2-chloro-4,6-di-(4-n-butylamino-1,2,2,6,6-pentamethylpiperidyl)-1,3,5-triazine and 1,2-bis(3-aminopropylamino)ethane; 8-acetyl-3-dodecyl-7,7,9,9-tetramethyl-1,3,8-triazaspiro-[4.5]decane-2,4-dione; 3-dodecyl-1-(2,2,6,6-tetramethyl-4-piperidyl)pyrrolidin-2,5-dione;3-dodecyl-1-(1,2,2,6,6-pentamethyl-4-piperidyl)pyrrolidin-2,5-dione; mixture of 4-hexadecyloxy- and 4-stearyloxy-2,2,6,6-tetramethylpiperidine; condensation product between N-N′-bis(2,2,6,6-tetramethyl-4-piperidyl)hexamethylenediamine and 4-cyclohexylamino-2,6-dichloro-1,3,5-triazine; condensation product between 1,2-bis(3-aminopropylamino)ethane and 2,4,6-trichloro-1,3,5-triazine, as well as 4-butylamino-2,2,6,6-tetramethylpiperidine (CAS Reg. Nr. [136504-96-6]; N-(2,2,6,6-tetramethyl-4-piperidyl)-n-dodecylsuccinimide; N-(1,2,2,6,6-pentamethyl-4-piperidyl)-n-dodecylsuccinimide; 2-undecyl-7,7,9,9-tetramethyl-1-oxa-3,8-diaza-4-oxospiro[4,5]decane; reaction product between 7,7,9,9-tetramethyl-2-cycloundecyl-1-oxa-3,8-diaza-4-oxospiro-[4,5]decane and epichlorohydrin; 1,1-bis(1,2,2,6,6-pentamethyl-4-piperidyloxycarbonyl)-2-(4-methoxyphenyl)ethene; N,N′-bis-formyl-N,N′-bis(2,2,6,6-tetramethyl-4-piperidyl)hexamethylenediamine; diester of 4-methoxy-methylenemalonic acid with 1,2,2,6,6-pentamethyl-4-hydroxypiperidine; reaction product of maleic anhydride/α-olefin copolymer with 2,2,6,6-tetramethyl-4-aminopiperidine or with 1,1,2,2,6-pentamethyl-4-aminopiperidine.

2.8 Oxamides such as, for example: 4,4′-dioctyloxyoxanilide; 2,2′-diethoxyoxanilide; 2,2′-dioctyloxy-5,5′-di-t-butoxanilide; 2,2′-didodecyloxy-5,5′-di-t-butyloxanilide; 2-ethoxy-2′-ethyloxanilide; N,N′-bis(3-dimethylaminopropyl)oxamide; 2-ethoxy-5-t-butyl-2′-ethyloxanilide and its mixtures with 2-ethoxy-2′-ethyl-5,4′-di-t-butoxanilide; and mixtures of di-substituted ortho- and para-methoxy oxanilides and mixtures of di-substituted ortho and para-ethoxy oxanilides.

2.9 2-(2-hydroxyphenyl)-1,3,5-triazines such as, for example: 2,4,6-tris(2-hydroxy-4-octyloxyphenyl)-1,3,5-triazine; 2-(2-hydroxy-4-octyloxyphenyl)-4,6-bis(2,4-dimethylphenyl)-1,3,5-triazine; 2-(2,4-dihydroxyphenyl)-4,6-bis(2,4-dimethylphenyl)-1,3,5-triazine; 2,4-bis-(2-hydroxy-4-propyloxyphenyl)-6-(2,4-dimethylphenyl)-1,3,5-triazine; 2-(2-hydroxy-4-octyloxyphenyl)-4,6-bis(4-methylphenyl)-1,3,5-triazine; 2-(2-hydroxy-4-dodecyloxyphenyl)-4,6-bis(2,4-dimethylphenyl)-1,3,5-triazine; 2-[2-hydroxy-4-(2-hydroxy-3-butyloxypropyloxy)phenyl]-4,6-bis(2,4-dimethylphenyl)-1,3,5-triazine; 2-[2-hydroxy-4-(2-hydroxy-3-octyloxypropyloxy)phenyl]-4,6-bis-(2,4-dimethylphenyl)-1,3,5-triazine; 2-(2-hydroxy-4-tridecyloxyphenyl)-4,6-bis(2,4-dimethylphenyl)-1,3,5-triazine; 2-[4-(dodecyloxy/tridecyloxy-2-hydroxypropoxy)-2-hydroxyphenyl]-4,6-bis(2,4-dimethylphenyl)-1,3,5-triazine; 2-[2-hydroxy-4-(2-hydroxy-3-dodecyloxypropoxy)phenyl]-4,6-bis-(2,4-dimethylphenyl)-1,3,5-triazine; 2-(2-hydroxy-4-hexyloxyphenyl)-4,6-diphenyl-1,3,5-triazine; 2-(2-hydroxy-4-methoxyphenyl)4,6-diphenyl-1,3,5-triazine; 2,4,6-tris[2-hydroxy-4-(3-butoxy-2-hydroxypropoxy)phenyl]-1,3,5-triazine; 2-(2-hydroxyphenyl)-4-(4-methoxyphenyl)-6-phenyl-1,3,5-triazine; 2-{2-hydroxy-4-[3-(2-ethylhexyl-1-oxy)-2-hydroxypropyloxy]phenyl}-4,6-bis(2,4-dimethylphenyl)-1,3,5-triazine.

3. “Metal-deactivators” such as, for example: N,N′-diphenyloxamide, N-salicylal-N′-salicyloyl-hydrazine, N,N′-bis(salicyloyl)hydrazine, N,N′-bis(3,5-di-t-butyl-4-hydroxyphenylpropionyl)hydrazine, 3-salicyloylamino-1,2,4-triazole, bis(benzylidene)oxallyl dihydrazide, oxanilide, isophthaloyl dihydrazide, sebacoyl bisphenylhydrazide, N,N′-diacetyladipoyl dihydrazide, N,N′-bis(salicyloyl)oxallyl dihydrazide, N,-N′-bis(salicyloyl) thiopropionyl dihydrazide.

4. Phosphites and phosphonites such as, for example: triphenyl phosphate, diphenyl alkyl phosphites, phenyl dialkyl phosphites, tris(nonylphenyl)phosphite, trilauryl phosphite, trioctadecyl phosphate, distearyl pentaerythritol diphosphite, tris(2,4-di-t-butylphenyl) phosphite, diisodecyl pentaerythritol diphosphite, bis(2,4-di-t-butylphenyl) pentaerythritol diphosphite, bis(2,6-di-t-butyl-4-methylphenyl)pentaerythritol diphosphite, diisodecyloxypentaerythritol diphosphite, bis(2,4-di-t-butyl-6-methylphenyl)pentaerythritol diphosphite, bis[2,4,6-tris(t-butylphenyl)]pentaerythritol diphosphite, tristearyl sorbitol triphosphite, tetrakis-(2,4-di-t-butylphenyl)-4,4′-diphenylenediphosphonite, 6-isooctyloxy-2,4,8,10-tetra-t-butyl-12H-dibenzo-[d,g]-1,3,2-dioxaphosphocine, 6-fluoro-2,4,8,10-tetra-t-butyl-12-methyldibenzo[d,g]-1,3,2-dioxaphosphocine, bis-(2,4-di-t-butyl-6-methylphenyl)methylphosphite, bis(2,4-di-t-butyl-6-methylphenyl)ethylphosphite; 2,2′,2″-nitrilo [triethyl-tris(3,3′,5,5′-tetra-t-butyl-1,1′-biphenyl-2,2′-diyl)-phosphite]; 2-ethylhexyl-(3,3′,5,5′-tetra-t-butyl-1,1′-biphenyl-2,2′-diyl)phosphite.

5. Hydroxylamines such as, for example: N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecylhydroxylamine; N-heptadecyl-N-octadecylhydroxylamine; N,N-dialkylhydroxylamines deriving from hydrogenated tallow amines.

6. Nitrons such as, for example: N-benzyl-α-phenyl- nitron; N-ethyl-α-methyl-nitron; N-octyl-α-heptyl-nitron; N-lauryl-α-undecyl-nitron; N-tetradecyl-α-tridecyl-nitron; N-hexadecyl-α-pentadecyl-nitron; N-octadecyl-α-heptadecyl-nitron; N-hexadecyl-α-heptadecyl-nitron; N-octadecyl-α-pentadecyl-nitron; N-heptadecyl-α-heptadecyl-nitron; N-octadecyl-α-hexadecyl-nitron; nitrons deriving from hydrogenated tallow amines.

7. Thiosynergizing agents such as, for example: dilauryl thiodipropionate; distearyl thiodipropionate.

8. Agents which are capable of destroying peroxides such as, for example, esters of β-thiodipropionic acid such as lauryl, stearyl, myristyl or tridecyl esters, mercaptobenzimidazole or zinc salt of 2-mercaptobenzimidazole, zinc dibutyldithiocarbamate, dioctadecyldisulfide, pentaerythritol tetrakis(β-dodecylmercapto)propionate.

9. Polyamide stabilizers such as, for example, copper salts combined with compounds of iodine and/or phosphorous, divalent manganese salts.

10. Basic co-stabilizers such as, for example: melamine, polyvinylpyrrolidone, dicyanodiamide, triallyl cyanurate, derivatives of urea, derivatives of hydrazine, amines, polyamides, polyurethanes, salts of alkaline metals and salts of earth-alkaline metals of fatty acids with a high molecular weight such as, for example, Ca-stearate, Zn-stearate, Mg-stearate, Mg-behenate, Na-ricinoleate, K-palmitate, antimonium-pyrocatecholate, tin-pyrocatecholate, zinc-pyrocatecholate.

11. Nucleating agents such as, for example: inorganic substances such as talc, metal oxides (for example, titanium dioxide or magnesium oxide), phosphates, carbonates or sulfates (preferably of earth-alkaline metals); organic compounds such as mono- or polycarboxylic acids and their salts (for example, 4-t-butylbenzoic acid, adipic acid, diphenylacetic acid, sodium succinate, sodium benzoate); polymeric compounds such as ionic copolymers (“ionomers”).

12. Fillers and reinforcing agents such as, for example: calcium carbonate, silicates, glass fibres, glass beads, asbestos, talc, kaolin, mica, barium sulfate, metal oxides and hydroxides, carbon black, graphite, wood flour and flours or fibres of other natural products, synthetic fibres.

13. Other additives such as, for example: plasticizers, pigments, lubricants, emulsifying agents, Theological additives, catalysts, slip agents, optical brighteners, flame-retardants (for example bromurates, chlorurates, phosphorates and phosphorous/halogen mixtures), anti-static agents, blowing agents.

14. Benzofuranones and indolinones such as, for example: 3-[4-(2-acetoxyethoxy)phenyl]-5,7-di-t-butyl-benzofuran-2-one; 5,7-di-t-butyl-3-[4-(2-stearoyloxyethoxy)phenyl]benzofuran-2-one; 3,3′-bis[5,7-di-t-butyl-3-[4-(2-hydroxyethoxy)phenyl]benzofuran-2-one; 5,7-di-t-butyl-3-(4-ethoxyphenyl)benzofuran-2-one; 3-(4-acetoxy-3,5-dimethylphenyl)-5,7-di-t-butyl-benzofuran-2-one; 3-(3,5-dimethyl-4-pivaloyloxyphenyl)-5,7-di-t-butyl-benzofuran-2-one; or those described in U.S. Pat. Nos. 4,325,863, 4,338,244, 5,175,312, 5,216,052 and 5,252,643; in German patents DE 4,316,611, 4,316,622 and 4,316,876; or in European patent applications Nr. 589,839 and 591,102.

The above stabilizers (co-stabilizers) can be optionally added to the organic polymers to be stabilized in a quantity ranging from 0.01% to 10% with respect to the total weight of the organic polymer to be stabilized.

The incorporation of compounds (a), (b), (c) and, optionally, (d), as single compounds or mixed with each other and possibly other stabilizers (co-stabilizers), in the organic polymers to be stabilized, can be carried out according to the methods known in the art, for example, before or during the processing, or the mixture dissolved or dispersed in a solvent, before or after its evaporation, can be applied to the organic polymer to be stabilized. The stabilizing mixture, object of the present invention, can also be used in masterbatch form containing from 2.5% to 25% by weight of said mixture.

The above mixture, optionally in the presence of other stabilizers (co-stabilizers), can also be added to the organic polymers to be stabilized, either after or during polymerization or before cross-linking.

The above mixture, optionally in the presence of other stabilizers (co-stabilizers), can be added to the organic polymers to be stabilized, in pure form or encapsulated in waxes, oils or polymers.

The above mixture, optionally in the presence of other stabilizers (co-stabilizers) which can be diluted or used in the molten state, can be sprayed into the organic polymers to be stabilized. This spraying can be advantageously effected during the deactivation of the polymerization catalyst, as the spraying can be effected using, for example, the vapor used for the deactivation.

In the case of spherically polymerized polyolefins, it may be advantageous to add the above mixture, optionally in the presence of other stabilizers (co-stabilizers), by means of spraying.

The organic polymers stabilized as described above can be used in a wide variety of forms such as, for example, films, fibers, tapes, moulding compositions, pro-files, ligands for coating materials such as powder coatings, adhesives or plaster, in particular.

The present invention also relates to a method for stabilizing organic polymers against degradation caused by oxygen, heat and/or light, which comprises the addition or application to said organic polymers of the stabilizing mixture, object of the present invention.

The 3-pyrazolidinones having general formula (I) or (II) can be used as such, as process stabilizers for organic polymers. A further object of the present invention is consequently the use of said compounds as process stabilizers for organic polymers, the polymeric compositions thus stabilized and the end-products obtained from their processing.

Some illustrative but non-limiting examples are provided hereunder for a better understanding of the present invention and for its embodiment.

### EXAMPLE 1

Stabilization of Polypropylene Subjected to Multiple High Temperature Extrusions

100 g of polypropylene in powder (Moplen FLF 20 of Montell Italia), having a melt flow index (MFI) of 12 g/min measured in accordance with ASTM D638 at 230° C. with 2.16 kg, are mixed with 0.05 g of calcium stearate and with the other stabilizers indicated in Table 1, which also specifies the quantities of the stabilizers used.

The above homogenized mixture is fed to a Brabender laboratory extruder with a feeding screw having a length of 475 mm, a diameter of 19 mm, a compression ratio of 1:4, which has the possibility of differentiated heating in four different zones of the feeding screw. The mixture is extruded through a hole having a diameter of 2 mm, with a screw rotation rate of 60 rpm and a temperature profile of 190° C., 230° C., 250° C., 280° C. and the MFI values obtained, measured as described above, at the 1^{st}, 3^{rd} and 5^{th} extrusion, are indicated in Table 1.

TABLE 1

| | MFI | | |
|---|---|---|---|
| STABILIZING MIXTURE | 1^{st} | 3^{rd} | 5^{th} |
| Anox 20 (0.0375%) | 14.8 | 18.7 | 24.3 |
| Alkanox 240 (0.0375%) | | | |
| Anox 20 (0.025%) | 12.8 | 14.2 | 17.8 |
| Alkanox 240 (0.0025%) | | | |
| Compound (IA) (0.01%) | | | |
| Anox 20 (0.02%) | 12.5 | 14.5 | 19.2 |
| Alkanox 240 (0.02%) | | | |
| Compound (IA) (0.01%) | | | |
| Anox 20 (0.02%) | 13.7 | 16.2 | 20.7 |
| Alkanox 240 (0.02%) | | | |
| Compound (IA) (0.0075%) | | | |

### EXAMPLE 2

Stabilization of Polypropylene Subjected to Multiple High Temperature Extrusions

100 g of polypropylene in powder (Moplen FLF 20 of Montell Italia), having a melt flow index (MFI) of 18 g/min measured in accordance with ASTM D638 on a Ceast Automatic Melt Flow Tester at 230° C. and under a 2.16 kg load, are mixed with 0.05 g of calcium stearate and with the other stabilizers indicated in Table 2, which also specifies the quantities of the stabilizers used.

The above homogenized mixture is fed to a Brabender PL 200 single screw laboratory extruder with a feeding screw having a length of 475 mm, a diameter of 19 mm, a compression ratio of 1:4, which has the possibility of differentiated heating in four different zones of the feeding screw. The mixture is extruded through a hole having a diameter of 2 mm, with a screw rotation rate of 60 rpm and a temperature profile of 200° C., 225° C., 250° C., 275° C. and the MFI values obtained, measured as described above, at the 1^{st}, 3^{rd} and 5^{th} extrusion, are indicated in Table 2.

TABLE 2

| | MFI | | |
|---|---|---|---|
| STABILIZING MIXTURE | 1^{st} | 3^{rd} | 5^{th} |
| Alkanox 240 (0.025%) | 11.2 | 11.9 | 13.6 |
| LL 62 (0.025%) | | | |
| Compound (IA) (0.025%) | | | |
| Alkanox 240 (0.025%) | 11.4 | 11.9 | 13.2 |
| LL 62 (0.025%) | | | |
| *Compound (IA) (0.025%) | | | |
| Alkanox 240 (0.025%) | 11.3 | 11.9 | 12.9 |
| LL 62 (0.025%) | | | |
| **Compound (IA) (0.025%) | | | |

*Compound (IA) was crystallized after treatment with active charcoal;
**Compound (IA) was crystallized twice from methylene Chloride/Cyclohexane 1:3 v/v.

The Yellow Index (YI) was measured on the granules after each extrusion for the polypropylene formulations reported in Table 2 using a Macbeth Colour Eye instrument mounting a light source D65 according to ASTM-E-313 and the data are reported in Table 3

TABLE 3

| | YI | | |
|---|---|---|---|
| STABILIZING MIXTURE | 1^{st} | 3^{rd} | 5^{th} |
| Alkanox 240 (0.025%) | −0.17 | 2.59 | 5.62 |
| LL 62 (0.025%) | | | |
| Compound (IA) (0.025%) | | | |
| Alkanox 240 (0.025%) | −0.58 | 2.40 | 5.36 |
| LL 62 (0.025%) | | | |
| *Compound (IA) (0.025%) | | | |
| Alkanox 240 (0.025%) | −0.82 | 1.40 | 3.91 |
| LL 62 (0.025%) | | | |
| **Compound (IA) (0.025%) | | | |

*Compound (IA) was crystallized after treatment with active charcoal;
**Compound (IA) was crystallized twice from methylene Chloride/Cyclohexane 1:3 v/v.

### EXAMPLE 3

Stabilization of Polypropylene Subjected to Multiple High Temperature Extrusions

100 g of polypropylene in powder form (Moplen FLF 20 of Montell Italia), having a melt flow index (MFI) equal to 18 g/min measured in accordance with the regulation ASTM D638 on a Ceast Automatic Melt Flow Tester at 230° C. and under a 2.16 kg load, are mixed with 0.05 g of calcium stearate and with the other stabilizers indicated in Table 4: Table 4 also specifies the quantities of the stabilizers used. The above homogenized mixture is fed to a Brabender PL 200 single screw laboratory extruder with a feeding screw having a length of 475 mm, a diameter of 19 mm, a compression ratio of 1:4, which has the possibility of differentiated heating in four different zones of the feeding screw. The mixture is extruded through a hole having a diameter of 2 mm, with a screw rotation rate of 60 rpm and a temperature profile of 200° C., 225° C., 250° C., 275° C. and the MFI values obtained, measured as described above, at the 1^{st}, 3^{rd} and 5^{th} extrusion, are indicated in Table 4.

TABLE 4

| | MFI | | |
|---|---|---|---|
| STABILIZING MIXTURE | 1^{st} | 3^{rd} | 5^{th} |
| Alkanox 240 (0.075%) | 15.3 | 22.1 | 30.8 |
| Compound (IA) (0.05%) | 11.9 | 13.2 | 15.9 |
| Alkanox 240 (0.05%) | 18.2 | 27.6 | 36.4 |
| Compound (IA) (0.025%) | 12.0 | 14.1 | 18.4 |

1. Stabilizing mixtures for organic polymers comprising:
(a) at least one compound belonging to the group of 3-pyrazolidinones;
(b) at least one compound belonging to the group or organic phosphates or phosphonites; and optionally
(c) at least one group belonging to the group of sterically hindered phenols; and, optionally,
(d) at least one group belonging to the group of sterically hindered amines.

2. The stabilizing mixtures for organic polymers according to claim 1, wherein the compounds belonging to the group of 3-pyrazolidinones (a) are selected from those having general formula (I) or (II): 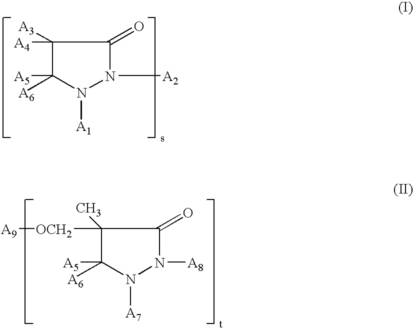
wherein:
A₁ represents a linear or branched C₁-C₁₈ alkyl group; a C₅-C₁₂ cycloalkyl group, said cycloalkyl group optionally mono-, di- or tri-substituted with a linear or branched C₁-C₄ alkyl group; a phenyl group, said phenyl group optionally mono-, di- or tri-substituted with a linear or branched C₁-C₄ alkyl or alkoxyl group, and/or mono-substituted with a hydroxyl group; a C₇-C₉ phenylalkyl group, said phenylalkyl group optionally mono-, di- or tri-substituted on the phenyl with a linear or branched C₁-C₄ alkyl group, and/or mono-substituted with a hydroxyl group; an —A₁₀—COOA₁₁ wherein A₁₀ represents a linear or branched C₁-C₆ alkylene group and A₁₁ represents a linear or branched C₁-C₁₈ alkyl group, a C₅-C₁₂ cycloalkyl group, said cycloalkyl group optionally mono-, di- or tri-substituted with a linear or branched C₁-C₄ alkyl group, a linear or branched C₃-C₁₈ alkenyl group, a C₇-C₉ phenylalkyl group, said phenylalkyl group optionally mono-, di- or tri-substituted on the phenyl with a linear or branched C₁-C₄ alkyl group;
A₃, A₄, A₅ and A₆, the same or different, represent a hydrogen atom; a linear or branched C₁-C₄ alkyl group; a phenyl group;
s is 1 or 2;
when s is 1, A₂ represents a hydrogen atom; a linear or branched C₁-C₁₈ alkyl group; a linear or branched C₃-C₆ alkenyl group; a C₇-C₉ phenylalkyl group, said phenylalkyl group optionally mono-, di- or tri-substituted on the phenyl with a linear or branched C₁-C₄ alkyl group; an —A₁₀—COOA₁₁ wherein A₁₀ and A₁₁ have the same meanings defined above; and, when A₂ represents a hydrogen atom, A₁ may also represent a group having general formula (III): 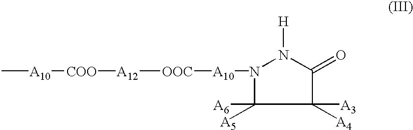
wherein A₃, A₄, A₅, A₆ and A₁₀ have the same meanings defined above and A₁₂ represents a linear or branched C₂-C₁₂ alkylene group; a C₄-C₁₂ alkylene group interrupted by 1, 2 or 3 oxygen atoms; a cyclohexylene group; a cyclohexylenedimethylene group; an isopropylidenedicyclohexylidene group;
when s is 2, A₂ represents a linear or branched C₂-C₁₂ alkylene group, or a xylylene group;
A₇ represents a phenyl group optionally mono-, di- or tri-substituted with a linear or branched C₁-C₄ alkyl or alkoxyl group, and/or mono-substituted with a hydroxyl group;
A₈ represents a hydrogen atom; a linear or branched C₁-C₁₈ alkyl group; a linear or branched C₃-C₆ alkenyl group; a C₇-C₉ phenylalkyl group, said phenylalkyl group optionally mono-, di-, or tri-substituted on the phenyl with a linear or branched C₁-C₄ alkyl group; an —A₁₀—COOA₁₁ group wherein A₁₀ and A₁₁ have the same meanings defined above;
t is 1, 2, 3 or 4;
when t is 1, A₉ represents an acyl-aliphatic, cycloaliphatic, aromatic, arylaliphatic or heterocyclic group containing not more than 22 carbon atoms; or one of the following groups having general formula (IVa)-(IVc): 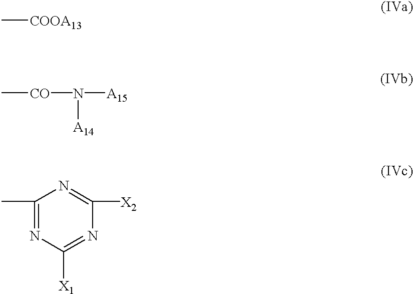
wherein A₁₃ has the same meanings as A₁₁ described above; A₁₄ and A₁₅, the same or different, have the same meanings as A₁₁ described above, or they represent a hydrogen atom, or a phenyl group, or A₁₄ and A₁₅ considered jointly with the nitrogen atom to which they are bound, represent a heterocyclic group with 5-7 atoms; X₁ and X₂, the same or different, represent an —O—A₁₆ group, or a group having the formula: 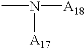
wherein A₁₆, A₁₇ and A₁₈, the same or different, have the same meanings as A₁₄ and A₁₅ described above, or A₁₇ and A₁₈ considered jointly with the nitrogen atom to which they are bound, represent a heterocyclic group with 5-7 atoms;
when t is 2, A₉ represents a diacyl-aliphatic, cycloaliphatic, aromatic, arylaliphatic or heterocyclic group containing not more than 22 carbon atoms; or one of the following groups having general formula (Va)-(Vc):
—COO—A₁₉—OOC— (Va)
—CONH—A₂₀—NHCO— (Vb) 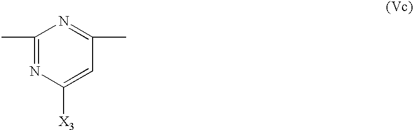
wherein A₁₉ represents a linear or branched C₂-C₁₂ alkylene group, a C₄-C₁₂ alkylene group interrupted by 1, 2 or 3 oxygen atoms, a cyclohexylene group, a cyclohexylenedimethylene group, an isopropylidenedicyclohexylidene group, a phenylene group, a xylylene group, an isopropylidenediphenylene group; A₂₀ represents a linear or branched C₂-C₁₂ alkylene group, a cyclohexylene group, a cyclohexylenedimethylene group, a methylidene-cyclohexylene group, a phenylene group, a methylphenylene group, a xylylene group, a methylenediphenylene group, an oxydiphenylene group, a group having the formula: 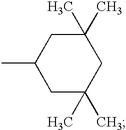
X₃ has the same meanings as X₁ and X₂ defined above;
when t is 3, A₉ represents a triacyl-aliphatic, aromatic or heterocyclic group containing not more than 18 carbon atoms, or a 2,4,6-triyl-1,3,5-triazine group;
when n is 4, A₉ represents a tetra-acyl-aliphatic or aromatic group containing not more than 18 carbon atoms.

3. The stabilizing mixtures for organic polymers according to claim 1, wherein the compounds belonging to the group of organic phosphates or phosphonites (b) are selected from those having the following general formulae (VI)-(XII): 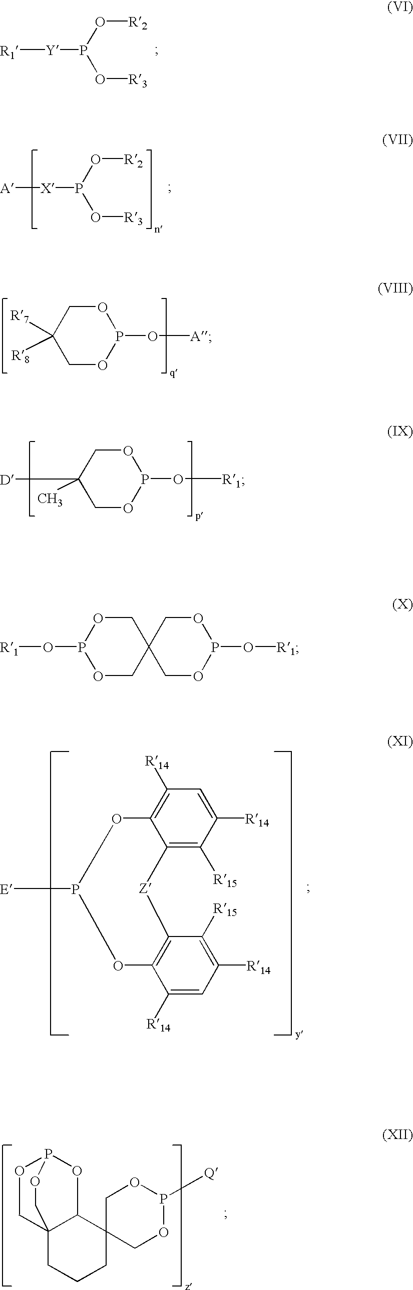
wherein:
n′ is 2, 3 or 4;
p′ is 1 or 2;
q′ is 2 or 3;
r′ is an integer ranging from 4 to 12, extremes included;
y′ is 1, 2 or 3;
z′ is an integer ranging from 1 to 6, extremes included;
when n′ is 2, A′ represents a C₂-C₁₈ alkylene group; a C₂-C₁₂ alkylene group containing an oxygen atom, a sulfur atom, or an —NR′₄— group; a group having general formula (XIII): 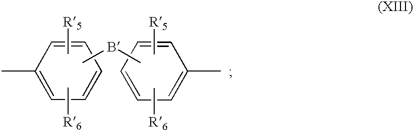
a group having general formula (XIV): 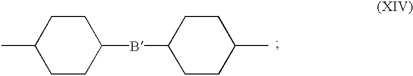
a phenylenic group;
when n′ is 3, A′ represents a group having general formula —C_{r′}H_{2r′-1}— wherein r′ has the same values described above;
when n′ is 4, A′ represents a group having the formula: 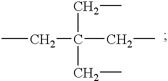
A″ has the same meanings defined above for A′ when n′ is 2;
B′ represents a direct bond; one of the following groups: —CH₂—, —CHR′₄—, —CR′₁R′₄—; a sulfur atom; a C₅-C₇ cycloalkylidene group; a cyclohexylidene group substituted with 1-4, C₁-C₄ alkyl groups in position 3, 4 and/or 5;
when p′ is 1, D′ represents a methyl group; and, when p′ is 2, D′ represents a —CH₂OCH₂— group;
when y′ is 1, E′ represents a C₁-C₁₈ alkyl group; an —OR′₁ group; a halogen atom;
when y′ is 2, E′ represents an —O—A″—O— group;
when y′ is 3, E′ represents one of the following groups: R′₄C(CH₂O—)₃, N(CH₂CH₂O—)₃;
Q′ represents a radical of an alcohol or a phenol with a valence z′, said radical being attached to the phosphorous atom by means of an oxygen atom;
R′₁, R′₂ and R′₃, each independently, represent a hydrogen atom; a halogen atom; one of the following groups: —COOR′₄—, —CN—, —CONR′₄R′₄; a C₂-C₁₈ alkyl group containing an oxygen atom, a sulfur atom, an —NR′₄— group; a C₇-C₉ phenylalkyl group; a C₅-C₁₂ cycloalkyl group; a phenyl group or a naphthyl group, said phenyl or naphthyl groups optionally substituted with halogen atoms, or with 1-3 C₁-C₁₈ alkyl or alkoxyl groups or with C₇-C₉ phenylalkyl groups; or they represent a group having general formula (XV): 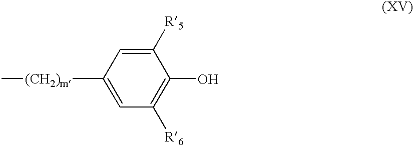
wherein m′ represents an integer ranging from 3 to 6, extremes included;
R′₄ represents a hydrogen atom; a C₁-C₁₈ alkyl group; a C₅-C₁₂ cycloalkyl group; a C₇-C₉ phenylalkyl group;
R′₅ and R′₆ each independently, represent a hydrogen atom; a C₁-C₈ alkyl group; a C₅-C₆ cycloalkyl group;
when q′ is 2, R′₇ and R′₈ each independently, represent a C₁-C₄ alkyl group; or, considered jointly, they represent a 2,3-dihydropentamethylene group;
when q′ is 3, R′₇ and R′₈ represent a methyl group;
R′₁₄ represents a hydrogen atom; a C₁-C₉ alkyl group; a cyclohexyl group;
R′₁₅ represents a hydrogen atom; a methyl group; or, when two or more R′₁₄ and R′₁₅ groups are present, said groups are the same or different to each other;
X′ and Y′ represent a direct bond; an oxygen atom;
Z′ represents a direct bond; a methylene group; a —C(R′₁₆)₂— group; a sulfur atom;
R′₁₆ represents a C₁-C₈ alkyl group.

4. The stabilizing mixtures for organic polymers according to claim 1, wherein the compounds belonging to the group of sterically hindered phenols (c) are selected from those having general formula (XIX): 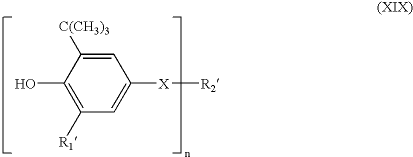
wherein:
R₁′ represents a C₁-C₄ alkyl group;
n is 1, 2, 3 or 4;
X represents a methylene group; or a group having general formula (XX) or (XXI): 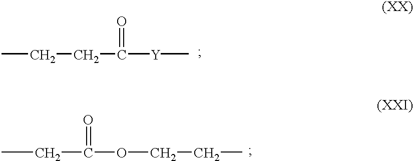
Y represents an oxygen atom; an —NH— group;
when n is 1, X represents a group having general formula (XX) wherein Y is attached to R₂′ and R₂′ represents a C₁-C₂₅ alkyl group;
when n is 2, X represents a group having general formula (XX) wherein Y is attached to R₂′ and R₂′ represents a C₂-C₁₂ alkylene group; a C₄-C₁₂ alkylene group containing one or more oxygen or sulfur atoms; or, when Y represents an —NH— group, R₂′ represents a direct bond;
when n is 3, X represents a methylene group; a group having general formula (XXI) wherein the ethylene group is bound to R₂′ and R₂′ represents a group having formula (XXII): 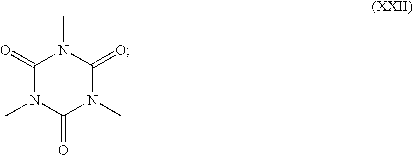
when n is 4, X represents a group having general formula (XX) wherein Y is bound to R₂′ and R₂′ represents a C₄-C₁₀ alkane-tetrayl group.

5. The stabilizing mixtures for organic polymers according to claim 1, wherein the compounds belonging to the group of sterically hindered phenols (c) consist of reactive antioxidant compounds containing a sterically hindered phenol group having general formula (I′) or (I′a): 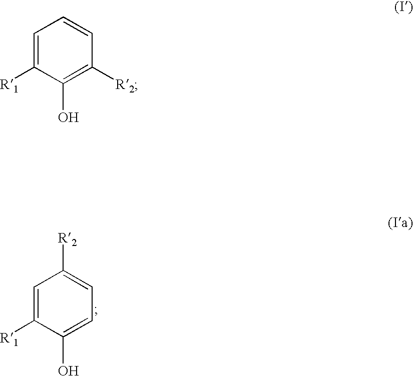
and more specifically, of reactive antioxidant compounds containing sterically hindered phenol groups having general formula (I′) and (I′a) selected from those having general formula (II′) or (II′a):

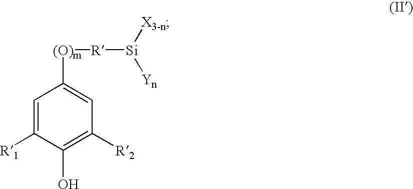

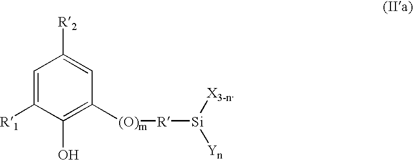

6. The stabilizing mixtures for organic polymers according to claim 1, wherein the compounds belonging to the group of sterically hindered amines (d) are selected from those comprising at least one group having general formula (XXIII) or (XXIV): 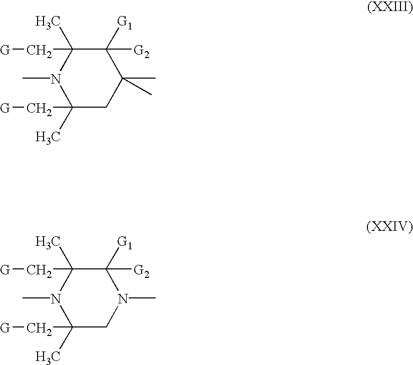
wherein:
G represents a hydrogen atom; or a methyl group;
G₁ and G₂, the same or different, represent a hydrogen atom; a methyl group; or they jointly represent an oxygen atom.

7. The stabilizing mixtures for organic polymers according to claim 1, wherein the compounds belonging to the group of sterically hindered amines (d) are selected from compounds (a′)-(h′) which comprise at least one group having general formula (XXIII) or (XXIV) according to claim 6.

8. The stabilizing mixtures for organic polymers according to claim 7, wherein the compounds belonging to the group of sterically hindered amines (d) are selected from compounds (a′) having general formula (XXV): 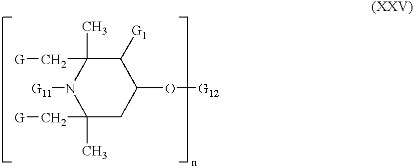
wherein n is a number ranging from 1 to 4, extremes included; G and G₁, independently, represent a hydrogen atom or a methyl; G₁₁ represents a hydrogen atom, O, a hydroxyl group, an NO group, a —CH₂CN group, a C₁-C₁₈ alkyl group, a C₃-C₈ alkenyl group, a C₃-C₈ alkinyl group, a C₇-C₁₂ arylalkyl group, a C₁-C₁₈ alkoxyl group, a C₅-C₈ cycloalkoxyl group, a C₇-C₉ phenylalkoxyl group, a C₁-C₈ alkanoyl group, a C₃-C₅ alkenoyl group, a C₁-C₁₈ alkanoyloxyl group, a benzyloxyl group, a glycidyl group, an OG₁₁′ group, wherein G₁₁′ represents a linear or branched C₁-C₁₀ alkyl group; a —CH₂CH(OH)—Z group wherein Z represents a hydrogen atom, a methyl, or a phenyl, G₁₁ preferably being hydrogen, a C₁-C₄ alkyl group, an allyl, a benzyl, an acetyl or an acryloyl; G₁₂, when n is 1, represents a hydrogen atom, a C₁-C₁₈ alkyl group, said alkyl group optionally containing one or more oxygen atoms, a cyanoethyl group, a benzyl, a glycidyl group, a monovalent radical of a carboxylic acid, of a carbamic acid or of an acid containing phosphorous, aliphatic, cycloaliphatic or arylaliphatic, unsaturated or aromatic, or a monovalent silyl radical, preferably a radical of an aliphatic carboxylic acid having from 2 to 18 carbon atoms, of a cycloaliphatic carboxylic acid having from 7 to 15 carbon atoms, of an α,β-unsaturated carboxylic acid having from 3 to 5 carbon atoms, of an aromatic carboxylic acid having from 7 to 15 carbon atoms, said carboxylic acids optionally substituted in the aliphatic, cycloaliphatic or aromatic part, with 1-3 —COOZ₁₂ groups, wherein Z₁₂ represents a hydrogen atom, a C₁-C₂₀ alkyl group, a C₃-C₁₂ alkenyl group, a C₅-C₇ cycloalkyl group, a phenyl or a benzyl; G₁₂, when n is 2, represents a C₂-C₁₂ alkylene group, a C₄-C₁₂ alkenylene group, a xylylene group, a divalent radical of a dicarboxylic acid, of a dicarbamic acid or of an acid containing phosphorous, aliphatic, cycloaliphatic, arylaliphatic or aromatic, or a divalent silyl radical, preferably a radical of an aliphatic dicarboxylic acid having from 2 to 36 carbon atoms, of a cycloaliphatic or aromatic dicarboxylic acid having from 8 to 14 carbon atoms, of an aliphatic, cycloaliphatic or aromatic dicarbamic acid, having from 8 to 14 carbon atoms, said dicarboxylic acids optionally substituted in the aliphatic, cycloaliphatic or aromatic part, with 1 or 2 —COOZ₁₂ groups wherein Z₁₂ has the same meanings defined above; G₁₂, when n is 3, represents a trivalent radical of an aliphatic, cycloaliphatic or aromatic tricarboxylic acid, optionally substituted in the aliphatic, cycloaliphatic or aromatic part, with a —COOZ₁₂ group wherein Z₁₂ has the same meanings defined above, or of an aromatic tricarbamic acid or of an acid containing phosphorous, or it represents a trivalent silyl radical; G₁₂, when n is 4, is a tetravalent radical of an aliphatic, cycloaliphatic or aromatic tetracarboxylic acid.

9. The stabilizing mixtures according to claim 7, wherein the compounds belonging to the group of sterically hindered amines (d) are selected from compounds (b′) having general formula (XXVI): 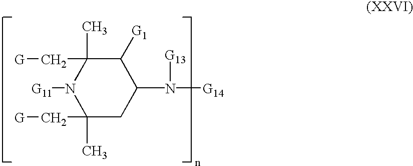
wherein n is 1 or 2; G, G₁ and G₁₁ have the same meanings described above under claim 8; G₁₃ represents a hydrogen atom, a C₁-C₁₂ alkyl group, a C₂-C₅ hydroxyalkyl group, a C₅-C₇ cycloalkyl group, a C₇-C₈ arylalkyl group, a C₂-C₁₈ alkanoyl group, a C₃-C₅ alkenoyl group, a benzoyl group, or a group having the following general formula: 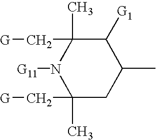
wherein G, G₁, G₁₁ have the same meanings defined above under claim 8; G₁₄, when n is 1, represents a hydrogen atom, a C₁-C₁₈ alkyl group, a C₃-C₈ alkenyl group, a C₅-C₇ cycloalkyl group, a C₁-C₄ alkyl group substituted with a hydroxyl group, with a cyano group, with an alkoxycarbonyl group or with a carbamide group, a glycidyl group, a group having the formula —CH₂—CH(OH)—Z or a group having the formula —CONH—Z wherein Z represents a hydrogen atom, a methyl or a phenyl; G₁₄, when n is 2, represents a C₂-C₁₂ alkylene group, a C₆-C₁₂ arylene group, a xylylene group, a group of formula —CH₂—CH(OH)—CH₂— or a group having the formula —CH₂—CH(OH)—CH₂—O—D—O— wherein D represents a C₂-C₁₀ alkylene group, a C₆-C₁₅ arylene group, a C₆-C₁₂ cycloalkylene group; or, on the condition that G₁₃ does not represent an alkanoyl group, an alkenoyl group or a benzoyl group, G₁₄ can also represent a 1-oxo-(C₂-C₁₂)-alkylene group, a divalent radical of a dicarboxylic acid or of a dicarbamic acid, aliphatic, cycloaliphatic or aromatic, or also a —CO— group; or, when n is 1, G₁₃ and G₁₄ considered jointly, can also represent a divalent radical of a 1,2- or 1,3-dicarboxylic acid, aliphatic, cycloaliphatic or aromatic.

10. The stabilizing mixtures according to claim 7, wherein the compounds belonging to the group of sterically hindered amines (d) are selected from compounds (c′) having general formula (XXVII): 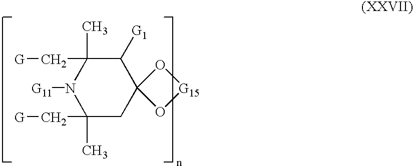
wherein n is 1 or 2; G, G₁ and G₁₁ have the same meanings described above under claim 8; G₁₅, when n is 1, represents a C₂-C₈ alkylene or hydroxyalkylene group, or a C₄-C₂₂ acyloxyalkylene group, and, when n is 2, it is a (—CH₂)₂C(CH₂—)₂ group.

11. The stabilizing mixtures according to claim 7, wherein the compounds belonging to the group of sterically hindered amines (d) are selected from compounds (d′) having general formula (XXVIIIA), (XXVIIIB) and (XXVIIIC), the compounds having general formula (XXVIIIC) being preferred: 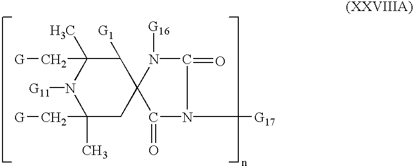 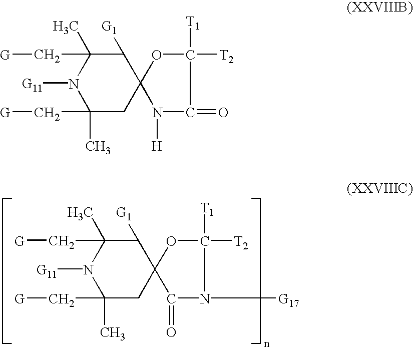
wherein n is 1 or 2, G, G₁ and G₁₁ have the same meanings defined above under claim 8; G₁₆ represents a hydrogen atom, a C₁-C₁₂ alkyl group, an allyl group, a benzyl, a glycidyl group or a C₂-C₆ alkoxyalkyl group; G₁₇, when n is 1, represents a hydrogen atom, a C₁-C₁₂ alkyl group, a C₃-C₅ alkenyl group, a C₇-C₉ arylalkyl group, a C₅-C₇ cycloalkyl group, a C₂-C₄ hydroxyalkyl group, a C₂-C₆ alkoxyalkyl group, a C₆-C₁₀ aryl group, a glycidyl group, or a group having the formula —(CH₂)ₚ—COO—Q or —(CH₂)ₚ—O—CO—Q wherein p is 1 or 2 and Q represents a C₁-C₄ alkyl group or a phenyl; G₁₇, when n is 2, represents a C₂-C₁₂ alkylene group, a C₄-C₁₂ alkenylene group, a C₆-C₁₂ arylene group, a group having the formula: —CH₂—CH(OH)—CH₂—O—D—O—CH₂—CH(OH)—CH₂— wherein D represents a C₂-C₁₀ alkylene group, a C₆-C₁₅ arylene group, a C₆-C₁₂ cycloalkylene group, or a group having the formula:
—CH₂CH(OZ′)CH₂—(OCH₂—CH(OZ′)CH₂)₂ wherein Z′ represents a hydrogen atom, a C₁-C₁₈ alkyl group, an allyl, a benzyl, or a C₂-C₁₂ alkanoyl group or a benzoyl; T₁ and T₂ each independently represent a hydrogen atom, a C₁-C₁₈ alkyl group, a C₆-C₁₀ aryl group, a C₇-C₉ arylalkyl group, said groups optionally substituted with a halogen atom or with a C₁-C₄ alkyl group; or T₁ and T₂ considered jointly with the carbon atom to which they are bound, form a C₅-C₁₄ cyloalkane ring.

12. The stabilizing mixtures according to claim 7, wherein the compounds belonging to the group of sterically hindered amines (d) are selected from compounds (e′) having general formula (XXIX): 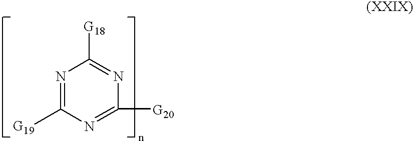
wherein n is 1 or 2, and G₁₈ represents a group having one of the following formulae: 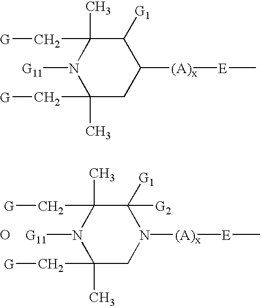
wherein G and G₁₁ have the same meanings defined above under claim 8; G₁ and G₂ represent a hydrogen atom, a methyl, or, considered jointly, they form a substituent ═O, E represents —O— or —NG₁₃—; A represents a C₂-C₆ alkylene group or a —(CH₂)₃—O— group; x is 0 or 1; G₁₃ represents a hydrogen atom, a C₁-C₁₂ alkyl group, a C₂-C₅ hydroxyalkyl group, a C₅-C₇ cycloalkyl group; G₁₉ has the same meanings as G₁₈ or it represents one of the following groups: —NG₂₁G₂₂, —OG₂₃, —NHCH₂OG₂₃, or —N(CH₂OG₂₃)₂; G₂₀, when n is 1, has the same meanings as G₁₈, or G₁₉, if n is 2, represents an —E—B—E— group wherein B represents a C₂-C₈ alkylene group optionally interrupted by 1 or 2 —N(G₂₁)— groups; G₂₁ represents a C₁-C₁₂ alkyl group, a cyclohexyl group, a benzyl, a C₁-C₄ hydroxyalkyl group, or a group having the following general formula: 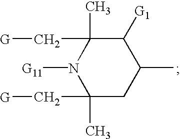
G₂₂ represents a C₁-C₁₂ alkyl group, a cyclohexyl group, a benzyl, a C₁-C₄ hydroxyalkyl group; G₂₃ represents a hydrogen atom, a C₁-C₁₂ alkyl group, a phenyl, or, G₂₁ and G₂₂, considered jointly, represent a C₄-C₅ alkylene or oxyalkylene group, such as: 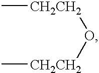
or a group having the formula: 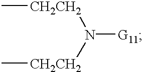
G₂₁ is a group having the general formula:

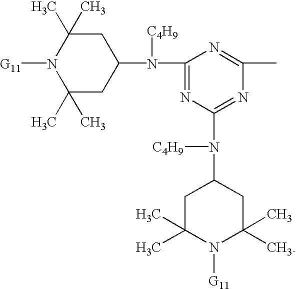

13. The stabilizing mixtures according to claim 7, wherein the compounds belonging to the group of sterically hindered amines (d) are selected from oligomeric or polymeric compounds (f′) whose recurrent structural unit contains a 2,2,6,6-tetramethylpiperidine radical, in particular polyesters, polyethers, polyamides, polyamines, polyurethanes, polyureas, polyaminotriazines, poly(meth)acrylates, poly(meth)acrylamides, and their copolymers containing said radical.

14. The stabilizing mixtures according to claim 7, wherein the compounds belonging to the group of sterically hindered amines (d) are selected from compounds (g′) having general formula (XXXIV): 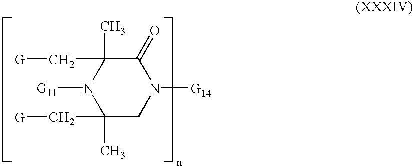
wherein n is 1 or 2, G and G₁₁ have the same meanings defined above under claim 8 and G₁₄ has the same meanings described above under claim 9, on the condition that G₁₄ can never represent the group —CONH—Z or the group —CH₂—CH(OH)—CH₂—O—D—O.

15. The stabilizing mixtures according to claim 7, wherein the compounds belonging to the group of sterically hindered amines (d) are selected from compounds (h′) having general formula (XXXV): 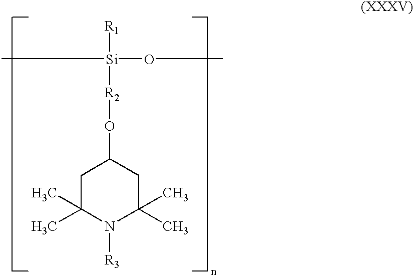
wherein R₁ represents a C₁-C₁₀ alkyl group, a C₅-C₁₂ cycloalkyl group optionally substituted with a C₁-C₄ alkyl group, a phenyl optionally substituted with a C₁-C₁₀ alkyl group; R₂ represents a C₃-C₁₀ alkylene group; R₃ represents a hydrogen atom, a C₁-C₈ alkyl group, O, a —CH₂CN group, a C₃-C₆ alkenyl group, a C₇-C₉ phenylalkyl group optionally substituted in the phenyl radical with a C₁-C₄ alkyl group, a C₁-C₈ acyl group, an —OR′₃ group wherein R′₃ represents a C₁-C₁₀ alkyl group; and n is a number ranging from 1 to 50, extremes included.

16. Polymeric compositions containing an organic polymer and an effective quantity of one of the stabilizing mixtures according to any of the previous claims.

17. The polymeric compositions according to claim 16, wherein the stabilizing mixtures are used in a combination with other stabilizers.

18. End-products obtained from the processing of the polymeric compositions according to claim 16 or 17.

19. A method for stabilizing organic polymers against degradation caused by oxygen, heat and/or light, which comprises the addition or application to said organic polymers of the stabilizing mixtures according to any of the claims from 1 to 15.

20. The use of 3-pyrazolidinones having general formula (I) or (II) according to claim 2, as process stabilizers for organic polymers.

21. Polymeric compositions containing an organic polymer and an effective quantity of at least one 3-pyrazolidinone having general formula (I) or (II) according to claim 2.

22. The polymeric compositions according to claim 21, wherein the 3-pyrazolidinones having general formula (I) or (II) are used in a combination with other stabilizers.

23. End-products obtained from the processing of the polymeric compositions according to claim 21 or 22.
